(19) United States
(12) Patent Application Publication
(10) Pub. No.: US 2026/0078264 A1
(43) Pub. Date: Mar. 19, 2026

(54) Tintable Aqueous Paint Composition Having High Block and Scrub Resistance Containing Non-Fluorinated Additives

(71) Applicant: SWIMC LLC, Cleveland, OH (US)

(72) Inventors: Mary Jane Hibben, Elburn, IL (US); Ashley Rodgers, Rockford, IL (US); Jacob S. Donlon, Chesterton, IN (US)

(21) Appl. No.: 18/986,002

(22) Filed: Dec. 18, 2024

Related U.S. Application Data
(63) Continuation-in-part of application No. 17/645,799, filed on Dec. 23, 2021, now abandoned.
(60) Provisional application No. 63/199,392, filed on Dec. 23, 2020.

(51) Int. Cl. C09D 5/02; C08F 220/14; C08K 5/05; C08K 5/521; C09D 7/45; C09D 7/63

(52) U.S. Cl. CPC C09D 5/027; C08F 220/14; C09D 5/022; C09D 7/45; C09D 7/63; C08F 2800/20; C08K 5/05; C08K 5/521

(57) ABSTRACT

The present invention is directed to a tintable aqueous coating composition or paint and coating and colorant systems comprising a latex copolymer and a non-fluorinated, non-polymeric additive. The coating composition or paint and coating and colorant systems show improved block resistance, scrub resistance and tack resistance without the use of fluorinated additives.

### CROSS-REFERENCE TO RELATED APPLICATIONS

The present application is a continuation-in-part of U.S. Ser. No. 17/645,799 filed on Dec. 23, 2021, which claims priority to U.S. Provisional 63/199,392, filed on Dec. 23, 2020, the entirety of both application is incorporated herein by reference.

### BACKGROUND OF THE INVENTION

Common architectural coatings compositions containing latex polymer particles also include a coalescent in addition to pigments and fillers. The coalescent functions as a solvent as well as a plasticizer for the polymer particles to soften the latex polymer particles and assist in the formation of a continuous coating or film after applying to a surface and allowing to dry.

Useful coalescents are generally stable in the presence of water, compatible with other ingredients typically used in paint formulations, particularly the latex polymers, such that the stability of the latex-based composition is not compromised. Typical coalescent agents contain volatile organic compounds (VOC) and are sufficiently volatile to escape when the applied coating composition is allowed to dry, but sufficiently nonvolatile to evaporate more slowly than other ingredients (e.g., drying retarders, antifreezes) that delay film formation.

For environmental and regulatory reasons, it has become imperative to develop paint and coating compositions without the use of volatile organic compounds (VOCs) or with limited use of VOCs. Coalescent agents of the type described in U.S. Pat. Nos. 6,762,230 and 7,812,079, for example, are low-VOC compounds that meet stringent environmental requirements, while facilitating film formation.

To make paint formulations of a desired color and finish, base paint compositions are often combined at a point-of-sale with low-VOC colorant compositions of the type described in U.S. Pat. No. 7,659,340, for example. However, typical low VOC paints with low VOC colorants may form soft, tacky coatings that show poor performance characteristics, such as poor block resistance and poor scrub resistance, for example. This situation is further complicated in deeply colored paint formulations that require high loading of the low VOC or zero-VOC colorants, which generally have residual non-volatile soft components, making hard film formation even more difficult.

One approach in the relevant art to provide improve block and scrub resistance is to add fluorosurfactants or fluorinated carbon compounds to architectural coatings in low VOC or zero-VOC coatings. While neither regulatory bodies nor the scientific community have shown toxicity or environmental persistence of conventional fluorosurfactants or fluorinated carbon-containing compounds that are commonly used in architectural coatings for this purpose to date, consumers often do not distinguish between conventional fluorosurfactants or fluorinated carbon-containing compounds that are commonly used in architectural coatings on the one hand and compounds like perfluorooctanoic acid (PFOA), which has historically been used in products like nonstick cookware and the manufacture of such products, and has been shown to be environmentally persistent, on the other.

From the foregoing, it will be appreciated that there is a need for latex compositions for use in architectural coatings formulations, including deeply colored formulations, that form hard films in the presence of low VOC or zero-VOC components, even in the absence or reduced presence of fluorinated carbon-containing agents, and demonstrate excellent performance characteristics, including block and scrub resistance.

### SUMMARY OF THE INVENTION

The present invention provides coating compositions that include latex copolymers, preferably formed from monomers including diacetone acrylamide (DAAM), and a non-fluorinated, non-polymeric additive, for use in low VOC, colored paint formulations and coating and colorant systems including the same. These compositions and composition and colorant systems include deeply colored formulations, made by adding colorant compositions to base paint formulations at a point-of-sale. Alternate, coating and colorant systems embodiments are also provided in which the non-fluorinated, non-polymeric additive is not provided directly in a tintable base-paint composition but is added by way of a colorant in a factory addition or a colorant or non-colored fluid from a point-of-sale tinting machine. In contravention of industry bias, systems that include the components described herein are preferably capable of film formation, and the resultant coatings demonstrate surprisingly excellent block resistance and scrub resistance. In preferred embodiments, the coating compositions include have less than 50 grams of VOC per liter and include less than 0.01 weight percent (“wt %”) of fluorosurfactants, if any.

In one embodiment, in addition to other components, the present invention provides paints (e.g., base paints) that include a latex polymer preferably formed form monomers including diacetone acrylamide (DAAM), more preferably a multistage latex polymer having at least a first stage and a second stage. In another embodiment, the present invention provides a method of making a paint formulation of a desired color by adding a colorant composition to a base paint formulation at a point-of-sale, wherein the base paint formulation includes a multistage latex polymer having at least a first stage and a second stage. In another embodiment, the present invention provides a method comprising the steps of preparing a first monomer mixture for the first stage, preparing a second monomer mixture for the second stage, and feeding the first and second monomer mixtures in a sequential feed process to form the multistage latex polymer, wherein the latex polymer has low VOC content, and is preferably capable of film formation in the absence of a coalescent.

In other embodiments, in addition to other components, the present invention provides base paints that include a latex polymer having one stage.

In other embodiments, in addition to other components, the present invention provides base paints that include a multistage latex polymer having a gradient Tg.

In certain embodiments, the non-fluorinated, non-polymeric additive comprises (i) an acid group that has been at least partially neutralized with a base, wherein the acid group includes at least one sulfur or phosphorus atom and (ii) a linear or branched, substituted or unsubstituted alkyl group. In certain embodiments, the non-fluorinated, non-polymeric additive is present in a tintable base-paint and in certain embodiments, the non-fluorinated, non-polymeric additive is added following the polymerization of the latex copolymer. In certain embodiments, the non-fluorinated, non-polymeric additive is present in a colorant composition that can be added to a tintable base-paint in a factory or by a point-of-sale colorant system to provide a tinted paint of a desired color. In certain embodiments the non-fluorinated, non-polymeric additive is present in either a colorant composition that can be added to a tintable base-paint in a factory or by a point-of-sale colorant system to provide a tinted paint of a desired color, or in the tintable base-paint, or both. In further embodiments, the non-fluorinated, non-polymeric additive is present in either a colorant composition that can be added to a tintable base-paint in a factory or by a point-of-sale colorant system to provide a tinted paint of a desired color, in the tintable base-paint, in a clear, non-colored fluid that dispenses into the tintable base paint from a point-of-sale colorant dispensing device, or in two or more of the colorant composition, tintable base paint, and clear, non-colored fluid.

In other embodiments, the present disclosure also describes a composition comprising an aqueous architectural paint formulation and/or an in-store tintable aqueous paint composition having less than 50 grams of VOC per liter and where the composition includes a latex copolymer formed from monomers including diacetone acrylamide (DAAM); one or more emulsifying surfactants (e.g., to facilitate polymerization); and a non-fluorinated, non-polymeric additive that includes (i) an acid group that has been neutralized with a base, wherein the acid group includes at least one sulfur or phosphorus atom and (ii) a linear or branched, substituted or unsubstituted alkyl group; wherein the composition includes less than 0.01 wt % of fluorosurfactants, if any, based on the total weight of the composition.

In other embodiments, the composition of the previous paragraph may also include other features or embodiments in any combination. These other features or embodiment may include one or more of the following: wherein the aqueous architectural paint formulation comprises an in-store tintable aqueous base paint; and/or wherein the aqueous architectural paint formulation comprises an in-store tintable aqueous deep base for use in forming deeply colored finish paint via addition of one or more colorant compositions; and/or wherein the latex copolymer is formed of at least 80 wt % of two or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex copolymer; and/or wherein the latex copolymer is formed of at least 90 wt % of three or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex copolymer; and/or wherein the latex copolymer includes at least about 0.5 wt % of DAAM, based on the total weight of monomers used to make the latex copolymer; and/or wherein the latex copolymer includes at least about 2.5 wt % of DAAM, based on the total weight of monomers used to make the latex copolymer; and/or wherein the latex copolymer is a multi-stage latex copolymer that includes at least two stages with different Tg values, and wherein the difference in Tg values is at least about 35° C.; and/or wherein the difference in Tg values is from about 35° C. to about 100° C.; and/or wherein at least one stage of the multi-stage latex copolymer has a calculated Tg of −35° C. to 20° C.; and/or wherein at least another stage of the multi-stage latex copolymer has a calculated Tg of from 0 to 120° C.; and/or wherein each of the recited stages is present in an amount of at least 20 wt %, based on the weight of monomers used to make each stage relative to the total amount of monomers used to make the latex copolymer; and/or wherein the composition has one or both of: (i) a pigment to volume concentration (PVC) of 30% or less or (ii) a 60-degree gloss rating of 35 or higher; and/or wherein the composition has one or both of (i) a pigment to volume concentration (PVC) of 20% or less or (ii) a 60-degree gloss rating of 70 or higher; and/or wherein the composition is a semi-gloss architectural paint formulation' and/or wherein the composition is a high gloss architectural paint formulation; and/or wherein the non-fluorinated, non-polymeric additive, prior to neutralization with base, comprises an alkyl phosphate ester, wherein the alkyl phosphate ester has the structure:

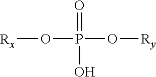

wherein: Rx represents a linear or branched substituted or unsubstituted alkyl group, Ry represents a linear or branched substituted or unsubstituted alkyl group, x represents the number of carbon atoms in the branched or linear alkyl group of Rx and ranges from 5 to 10, y represents the number of carbon atoms in the branched or linear alkyl group of Ry and is 0 (in which case Ry is a hydrogen atom) or ranges from 5 to 10; and/or wherein Rx and Ry include only carbon and hydrogen atoms, and wherein at least one, or both, of Rx and Ry include eight carbon atoms; and/or wherein the non-fluorinated, non-polymeric additive is a reaction product of ingredients including 1-octanol; and/or wherein the non-fluorinated, non-polymeric additive is present in the composition in an amount of at least 0.2 pounds per 100 gallons of the composition; and/or wherein the non-fluorinated, non-polymeric additive is present in the composition in an amount of no more than about 4 pounds per 100 gallons of the composition; and/or wherein the composition is (i) an in-store tintable aqueous base paint for use in forming deeply colored architectural finish paint via addition of one or more colorant compositions or (ii) a deeply colored architectural finish paint, and wherein the composition has an early hot block resistance rating after one hour of at least 6; and/or wherein the composition when applied to a black mylar substrate and allowed to cure for 1 week at ambient temperature to achieve an average dry coating thickness of 2.6 mil has a scrub resistance of at least 600 scrubs; and/or wherein the composition contains less than 1000 parts per billion (ppb) of elemental fluorine as it occurs in all chemical species in the composition, if any is present; and/or wherein the composition is a deeply colored architectural finish paint that includes at least about 10 ounces of colorant per 1 gallon; and/or wherein the composition includes at least 20 wt % of the multi-stage latex copolymer, based on solids of the multi-stage latex copolymer relative to total solids in the composition; and/or wherein the composition includes a polyhydrazide; and/or wherein the composition includes methyl-o-benzoyl-benzoate; and/or wherein the emulsifying surfactant is one or more non-ionic surfactants, anionic surfactants, or combinations thereof; and/or wherein the latex copolymer is polymerized using the one or more emulsifying surfactants; and/or wherein the one or more emulsifying surfactants is chemically distinct from the non-fluorinated, non-polymeric additive; and/or wherein the non-fluorinated, non-polymeric additive does not facilitate polymerization of monomers in an aqueous media.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### Selected Definitions

Unless otherwise specified, the following terms as used herein have the meanings provided below.

The term “component” refers to any compound that includes a particular feature or structure. Examples of components include compounds, monomers, oligomers, polymers, and organic groups contained there.

The term “double bond” is non-limiting and refers to any type of double bond between any suitable atoms (e.g., C, O, N, etc.). The term “ethylenically unsaturated” refers to compounds that include a carbon-carbon double bond (i.e. —C═C—).

The term “volatile organic compound” (“VOC”), as defined by the Environmental Protection Agency (EPA) in 40 C.F.R. 51.100(s), refers to any compound of carbon, excluding carbon monoxide, carbon dioxide, carbonic acid, metallic carbides or carbonates, and ammonium carbonate, which participates in atmospheric photochemical reactions. Typically, volatile organic compounds have a vapor pressure equal to or greater than 0.1 mm Hg. As used herein, “volatile organic compound content” (“VOC content”) in a coating composition, colorant composition, latex copolymer, or other composition is as measured by ASTM method D6886-18, and means the weight of VOC per volume of the coating solids, and is reported, for example, as grams VOC per liter (g/L). With respect to a latex copolymer described here, VOC may also be reported as grams VOC per 100 grams of latex copolymer (with reference to grams of the solids in the latex). EPA Method 24 may be used to determine VOC in the alternative. If unstated or otherwise unclear from context with respect to a particular VOC measure, in the present application, ASTM method D6886-18 is the method used.

As used herein, the term “glass transition temperature” or “Tg” refers to the temperature at which an amorphous, solid material undergoes a reversible transition to a molten, rubber-like state. Unless otherwise indicated, the Tg values described herein are theoretical values predicted using the Fox equation. Application of the Fox equation to estimate the Tg of polymers is well known in the art.

Sheen may also sometimes be referred to as gloss. In a coating, a gloss finish indicates that the surface which has a coating applied to it (i.e., is finished) is shiny or glass-like. The gloss of a surface is described as the reflection of light from the surface that is independent of color. ASTM D523 may be used to measure sheen. The prescribed angle at which light is reflected off the surface may vary, but for the purposes of this disclosure to measure 85 Sheen, is measured at 85° relative to the surface reflecting the light. ASTM D523 may also be used to describe 60 Gloss, which is measured at 60° relative to the surface reflecting the light. Gloss may also refer to the gloss intensity measured at 20, 60, or 85 degrees and is determined according to ASTM D523. One of skill in the art is able to determine relative levels of gloss (low versus high) in context of each coating.

The term “substantially free of VOC” means that the composition of the present invention contains less than about 50 g/L VOC. Unless otherwise indicated, the terms “low VOC” and “substantially free of VOC” are used interchangeably herein. The term “essentially free of VOC” means that the compositions of the present invention contain less than 5 g/L of VOCs. The terms, “zero VOC” and “essentially free of VOC” are used interchangeably herein.

The term “substantially free,” when applied to components of a composition and not to VOC levels, means that the compositions of the present invention contain no more than about 5 wt % of a particular component, based on total weight of solids in the composition. For example, a composition of the present invention that is substantially free of coalescent contains no more than about 5 wt % coalescent. A composition of the present invention that is essentially free of coalescent contains no more than about 0.5 wt % of coalescent.

As used herein, the term “colorant” refers to a dispersion of pigment in a mobile phase, typically in liquid form, which is added to a coating composition to modify or alter its color or hue, typically at a point-of-sale, but also for in-factory tinting. As the term is used herein, a colorant may include one or more pigments, dyes and/or inks, along with other additives. As used herein, a colorant with a color designation indicates that the respective colorant comprises a corresponding color. For example, a “yellow colorant,” as used herein, would comprise one or more yellow pigments, dyes, or inks (e.g., yellow oxide).

As used herein, the term “base paint” means a composition that includes a vehicle component containing a binder or resin component. As used herein, the base paint formulation includes water as the vehicle, a latex polymer as the binder or resin component, and may also include one or more pigments or fillers used to tone or opacify the base paint as the pigment component dispersed into the base paint.

The base paints described herein are typically “in-store tintable,” meaning that the base paints are present in containers (such as paint cans, for example) and can be tinted or colored by adding a colorant composition in the store, i.e., at a point of sale, to provide a paint formulation of a desired color and finish. (In some embodiments, the base paints may alternatively be “factory tinted” or “package tinted”, where, for example, a tinted or deeply colored coating composition is not tinted in-store, but rather is tinted during manufacturing.) In certain embodiments, the base paints described herein are tinted from a point-of-sale system employing a “colorant array,” or limited set of colorants that can be used to tint the base paint from a point-of-sale tinting machine. A conceptual example of a colorant array according to the present invention is shown in FIG. 1. Notably, a colorant array 10 in FIG. 1 further includes an optional non-colored fluid 20. The non-colored fluid need not be present in a colorant array according to the present invention, but in certain embodiments where the non-colored fluid is present, the non-colored fluid further contains the non-fluorinated, non-polymeric additive of the present invention, and can be metered into the base-paint to provide a desired, resulting concentration in the base paint along with or without desired colorant.

As used herein, the term “container” means any vessel (either with or without a lid or other type of closure) used to store, mix, tint or color a paint formulation, and includes the vessels in which paints are typically marketed and sold. Suitable containers include paint cans, paint bottles, containers made of metal, containers made of plastic and/or other polymeric materials, and the like.

The term “headspace,” as used herein, refers to the volume remaining in a container after the container has been filled with a base paint.

The term “scrub resistance,” as used herein, refers to the ability of the surface of a coating film or paint film to resist being worn away or to maintain its original appearance when rubbed with or against an abrasive surface, typically during cleaning. To measure scrub resistance, a standard test method, ASTM D2486-96 (Standard Test Method for Scrub Resistance of Wall Paints) can be used.

As used herein, the term “block resistance” means the ability of a coating film or paint film, when applied to two surfaces, not to stick to itself on prolonged contact when pressure is applied for a defined period of time. It is a measure of the degree of hardness and/or degree of cure of a film of a coating composition or paint formulation, and is measured by a standard test method, ASTM D4946-89 (Reapproved 2017; Standard Test Method for Blocking Resistance of Architectural Paints). “Hot block resistance,” as used herein, is conducted at 50° C. with ratings assessed after 1 day, 3 days, and 7 days of cure time.

As used herein, the term “early hot block resistance” means the ability of a coating film or paint film, when applied to two surfaces, not to stick to itself on contact when pressure is applied for a defined period of time at an elevated temperature and over a shorter period of time as compared to measures of block resistance as defined in the paragraph above. Early hot block resistance is a stringent test that can show high performance of a paint film or coating film and is an important measure as, in addition to the information provided by a block resistance test, it indicates a paint film or coating film's ability to not stick to itself in a hot climate or heated indoor setting and to do so early on in the curing process, thus allowing early handling of a coated article (e.g., stacking of painted trim pieces or closing of a painted door in a painted doorframe). Early hot block resistance is measured and reported herein using the method described above for hot block resistance, but wherein the one kilogram weight is only applied for 15 minutes (instead of 30), and ratings are assessed after 1 hour and 4 hours of cure time.

Opacity or hiding (in some approaches) generally refers to the ability of a film to scatter light based on the thickness of the film. The Opacity is often expressed as S/mil and may be in the form of Kubelka-Munk scattering coefficients as determined using a modification of ASTM D 2805-70 as described in J. E. Mchutt and H. L. Ramsay in American Paint and Coatings Journal, April 1988, p. 46 by the weight drawdown method, which is incorporated herein by reference.

The terms “point-of-sale” and “retail” when used with respect to a site, location, store or other outlet means a place at which custom-mixed paints or stains are tinted and mixed in small batch lots (e.g., one half pint, one pint, one quart, one liter, one gallon, four liter, five gallon or 20 liter containers, corresponding to containers from about 0.2 to 20 L) for sale to end-users (e.g., painters, builders and homeowners). Representative point-of-sale retail, wholesale or combined retail/wholesale outlets include paint stores, hardware stores, building supply stores (including warehouses), and distribution centers.

The term “pigment” includes both colored, dispersible solid particulate materials and colored dispersible or soluble dye materials, wherein the material imparts visually noticeable color to a base paint or stain when 5 wt. % (in the case of a colored, dispersible solid particulate) or 0.05 wt. % (in the case of a colored, dispersible or soluble dye) of the material is added to (e.g., dispensed into) the base paint or stain. The presence or absence of visually noticeable color may be assessed by preparing drawdown samples of the base paint or stain with and without the pigment, casting such samples as 25 micrometer (μm) dry thickness coated films over the white part of a BYK-Gardner No. PA-2811 opacity drawdown chart (from BYK-Gardner USA) or comparable chart, and examining the coated films under normal overhead interior illumination.

The term “pigment volume concentration” (PVC) when used in respect to a paint, stain or colorant means the total percentage of dried coating volume occupied by all pigment species in the coating.

The term “longest chain” refers to the longest backbone of a particular chemical group. As used herein and with respect to a particular group, this term does not necessitate the existence of branching or other chemical chains in the group or off of the longest chain.

The term “König hardness” or “pendulum hardness” as used with respect to a composition herein means the pendulum hardness as assessed according to standard test method ASTM D4366-16 (Standard Test Methods for Hardness of Organic Coatings by Pendulum Damping Tests). Such hardness can generally be evaluated by the number of swings of the pendulum contacting a coating applied to a steel Q panel (sold by Q-LAB). A normalized pendulum hardness can be calculated by multiplying the number of swings across a coating (occurring at a specified time after the application of a coating composition to a Q panel) by the thickness of an applied coating. For example, if 25 swings occur on a 30 μm thick portion of a coating, the normalized pendulum hardness would be 750 (25 times 30). The thickness of a coating can be measured using an Eclometer (sold by Eclometer, Inc.). A cured coating formed from the coating compositions described herein can have a normalized pendulum hardness ranging from 400 to 3800, 1000 to 3500, 1300 to 3300, 1600 to 3000, 1900 to 2900, or 2100 to 2500 over an initial curing period.

Unless otherwise indicated, a reference to a “(meth)acrylate” compound (where “meth” is bracketed) is meant to include both acrylate and methacrylate compounds.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the term “polymer” includes both homopolymers and copolymers (i.e., polymers of two or more different monomers).

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, “a.” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DESCRIPTION OF THE DRAWING

FIG. 1 is a drawing of a colorant array according to certain embodiments of the present invention.

### DETAILED DESCRIPTION

Embodiments of the present invention feature coating compositions that include latex copolymers and a non-fluorinated, non-polymeric additive, for use in low VOC, colored paint formulations and coating and colorant systems including the same. These compositions and composition and colorant systems include deeply colored formulations, made by adding colorant compositions to base paint formulations at a point-of-sale. Alternate coating and colorant systems embodiments are also provided in which the non-fluorinated, non-polymeric additive is not provided directly in a tintable base-paint composition but is added by way of a colorant in a factory addition or a colorant or non-colored fluid from a point-of-sale tinting machine. In contravention of industry bias, systems that include the components described herein are preferably capable of film formation, and the resultant coatings demonstrate surprisingly excellent block resistance and scrub resistance without the use of fluorosurfactants.

In certain preferred embodiments, the latex copolymer of the present invention comprises a multistage latex polymer. The term “multistage,” as used herein with respect to a latex means the latex polymer was made using discrete, sequential charges of two or more monomers or monomer mixtures, or was made using a continuously-varied charge of two or more monomers. A multistage polymer is distinct from a single stage polymer made using one type of monomer blended with distinct polymer seed particles.

A multistage latex does not necessarily exhibit a single Tg inflection point as measured by differential scanning calorimetry (DSC). For example, a DSC curve for a multistage latex made using discrete charges of two or more monomers may exhibit two or more Tg inflection points. In cases where a DSC curve shows only a single Tg inflection point, or even no Tg inflection points, it may be difficult to determine whether the latex is single stage or multistage, as the observation of a Tg inflection point depends on various factors, including the relative concentration of monomers in a particular stage. The presence or absence of Tg inflection points on a DSC curve is not dispositive, but a multistage latex may be described in terms of the theoretical Tg values for each monomer stage, as determined by the Fox equation.

In an embodiment, a method of making a multistage latex having at least a first stage and a second stage is described herein. The method includes steps of providing a first monomer or monomer mixture for the first stage, providing a second monomer or monomer mixture for the second stage; and feeding the first and second monomers or monomer mixtures into a reaction vessel to form a multistage latex that is capable of film formation with or without a coalescent agent.

Various methods can be used to prepare the multistage latex described herein, including for example, sequential monomer feed and continuously varying monomer feed techniques. In a sequential monomer feed process, a first monomer or monomer mixture is fed during the early stages of polymerization, and a second monomer (i.e. a different monomer, or a mixture of monomers present in different ratios than in the first monomer mixture) is fed during later stages of polymerization. In a varying monomer feed process, a first monomer composition is fed, followed by the addition of a second monomer at certain points in the polymerization process, and at different speeds. By controlling the type of monomers selected for the feed process, a multistage latex suitable for low VOC coating compositions or paints may be formed, and the latex preferably provides excellent performance characteristics, such as, for example, block resistance, scrub resistance, and the like, for such coating or paint formulations.

Preferred multistage latexes include at least two stages (e.g., two, three, or four or more stages) with different Tg values (not considering any Tg that may be associated with an optional “seed”). Preferably, the at least two stages exhibit Tg values that differ by at least about 20° C., at least about 30° C., at least about 35° C., at least about 40° C., at least about 45° C., at least about 50° C., at least about 55° C., at least about 60° C., at least about 70° C., at least about 80° C., at least about 90° C., or at least about 100° C. In certain preferred embodiments, the at least two stages have Tg values that differ by from about 35° C. to about 100° C. In some embodiments, the higher Tg stage (or “hard” stage) has a Tg of from about 0 to about 120° C., more typically from about 40 to about 80° C., and even more typically from about 50 to about 70° C. In some embodiments, the lower Tg stage (or “soft” stage) has a Tg of from about −35 to about 20° C., more typically from about −25 to about 15° C., and even more typically from about −10 to about 10° C. In some embodiments, each of the at least two stages constitute at least 15 weight percent (“wt %”), at least 20 wt %, at least 25 wt %, at least 30 wt %, at least 35 wt %, or at least 40 wt % of the multi-stage latex, based on the total weight of monomers used to make the latex (and not factoring the weight of any optional seed used).

In an embodiment, the multistage latex composition described herein is made by a sequential monomer feed process. In an aspect, polymerization begins with a higher Tg monomer feed followed by a lower Tg monomer feed, and vice-versa. In a preferred aspect, polymerization begins with a higher Tg monomer feed, followed by a lower Tg monomer feed.

In an embodiment, the multistage latex composition described herein is made using varying monomer feeds. The resulting polymer will typically have a DSC curve that exhibits no Tg inflection points, and could be said to have an essentially infinite number of Tg stages. The resultant multistage latex will have a gradient Tg from high to low; or vice-versa, depending on the order that monomers of high Tg are fed into the reaction.

In a preferred aspect, the multistage latex described herein is made by a sequential monomer feed process using at least two distinct feeds of monomers. In an aspect, a “high” Tg stage (i.e., a hard stage) is fed first into a reactor vessel, and a “low” Tg stage (i.e. a soft stage) is added at a later stage in the process. A multistage latex may be formed, and after coalescence, the composition will typically display two distinct Tg values, or at least one Tg corresponding to the monomer stage present at higher concentration. Without being bound to theory, it is expected that no distinct Tg will be observed or detected by DSC for a monomer or monomer mixture in a particular stage that is present in very small quantities relative to the other monomer or monomer mixture.

In an aspect, the multistage latex optionally includes a “seed” phase, i.e., a relatively small monomer or polymer particle, but the seed is not required, nor essential for preparation or optimal performance of the multistage latex when used in a coating composition or paint formulation.

Latex polymers are typically formed via emulsion polymerization techniques employing one or more emulsifying surfactants. Accordingly, preferred multistage and single stage latex polymers described herein are preferably made using one or more emulsifying surfactants to facilitate emulsion polymerization of the monomers in the aqueous media. In preferred embodiments, such emulsifiers are chemically distinct from the non-fluorinated, non-polymeric additive, which is typically combined with the latex polymer at some time following completion of emulsion polymerization. Thus, in preferred embodiments, the compositions of the present disclosure (e.g., resin dispersions for use in forming a paint or a base paint or fully formulated paints) include two or more surfactants—at least one of which is the primary surfactant employed in making the latex polymer and another of which is the non-fluorinated, non-polymeric additive described herein. Examples of suitable emulsifying surfactants for use in making latex polymers include nonionic surfactants such as, for example, tert-octylphenoxyethylpoly(39)-ethoxyethanol, dodecyloxypoly(10)ethoxyethanol, nonylphenoxyethyl-poly(40)ethoxyethanol, polyethylene glycol 2000 monooleate, ethoxylated castor oil, fluorinated alkyl esters and alkoxylates, polyoxyethylene (20) sorbitan monolaurate, sucrose monococoate, di(2-butyl)-phenoxypoly(20)ethoxyethanol, hydroxyethylcellulosepoly butyl acrylate graft copolymer, dimethyl silicone polyalkylene oxide graft copolymer, poly(ethylene oxide)poly(butyl acrylate) block copolymer, block copolymers of propylene oxide and ethylene oxide, 2,4,7,9-tetramethyl-5-decyne-4,7-diol ethoxylated with ethylene oxide, N-polyoxyethylene(20)lauramide, N-lauryl-N-polyoxyethylene(3)amine and poly(10)ethylene glycol dodecyl thioether; and anionic emulsifiers such as, for example, sodium lauryl sulfate, sodium dodecylbenzenesulfonate, potassium stearate, sodium dioctyl sulfosuccinate, sodium dodecyldiphenyloxide disulfonate, nonylphenoxyethylpoly(1)ethoxyethyl sulfate ammonium salt, sodium styrene sulfonate, sodium dodecyl allyl sulfosuccinate, linseed oil fatty acid, sodium, potassium, or ammonium salts of phosphate esters of ethoxylated nonylphenol or tridecyl alcohol, sodium octoxynol-3-sulfonate, sodium cocoyl sarcocinate, sodium 1-alkoxy-2-hydroxy-propyl sulfonate, sodium alpha-olefin (C.sub. 14-C.sub. 16) sulfonate, sulfates of hydroxyalkanols, tetrasodium N-(1,2-dicarboxy ethyl)-N-octadecylsulfosuccinamate, disodium N-octadecylsulfosuccinamate, disodium alkylamido polyethoxy sulfosuccinate, disodium ethoxylated nonylphenol half ester of sulfosuccinic acid and the sodium salt of tert-octylphenoxyethoxypoly(39)ethoxyethyl sulfate. In one embodiment, the primary or emulsifying surfactant herein may be used in an amount of about 0.2 to about 5 weight percent (relative to the total weight of the resin solids and/or the monomers that are emulsion polymerized).

In an aspect, the relative positions of the first and second phases may be internal and external respectively, or vice-versa. In another aspect, the first and second phases may be neighboring or adjacent. Without being bound by theory, it is believed that the relative position of the stages of the multistage latex is influenced by the method used to make the latex. By controlling the monomers used in each stage of the sequential monomer feed process, the multistage latex described herein will contain about 10 wt % to 50 wt %, preferably about 20 to 40 wt %, more preferably about 25 to 35 wt % of monomers of the first stage, i.e., high Tg or hard stage monomers in some embodiments, and about 50 wt % to 90 wt %, preferably about 60 to 80 wt %, more preferably about 65 to 75 wt % of monomers of the second stage, i.e., low Tg or soft stage monomers, based on the total weight of monomers used to make the respective stage relative to the total weight of monomers used to make the latex (and not factoring the weight of any optional seed used).

In an embodiment, by controlling the monomers used for each stage of the sequential monomer feed process, a multistage latex composition with optimal minimum film forming temperature (MFFT) is obtained. The MFFT is the minimum temperature at which the multistage latex composition will form a continuous film, i.e. the temperature below which coalescence does not occur. The MFFT of the multistage latex composition as described herein is preferably less than about 30° C., more preferably less than about 20° C. A base paint or other paint that includes the multistage latex described herein has MFFT of less than about 30° C., preferably less than about 20° C.

In an embodiment, the multistage latex described herein preferably includes at least two polymer portions. In a preferred embodiment, the multistage latex includes at least a first stage and a second stage. In an aspect, the multistage latex includes up to about 50%, preferably about 10% to 40%, more preferably 15% to 35% of one or more monomers or a mixture of monomers comprising the first stage. In an aspect, the multistage latex includes about 50%, preferably 60% to 90%, more preferably 75% to 85% of one or more monomers or a mixture of monomers comprising the second stage.

In certain embodiments, the latex copolymer is a single stage latex, derived by polymerization in a single stage process of an emulsion including one or more ethylenically unsaturated monomers. As understood by those of skill in the art, the emulsion preferably includes a surfactant (e.g., other than the non-fluorinated, non-polymeric additive described herein) that helps facilitate emulsion polymerization of the monomers. By controlling the type of monomers used in the emulsion polymerization, a single stage latex suitable for low VOC coating compositions or paints may be formed, and the latex preferably provides excellent performance characteristics, such as, for example, block resistance, scrub resistance, and the like, for such coating or paint formulations.

In an embodiment, by controlling the monomers used in the single stage latex synthesis, a single stage latex composition with optimal MFFT is obtained. The MFFT of the single stage latex composition as described herein is preferably less than about 30° C., more preferably less than about 20° C. A base paint or other paint that includes the multistage latex described herein has MFFT of less than about 30° C., preferably less than about 20° C.

Preferred single stage latex copolymers exhibit a Tg of from about −10° C. to about 20° C. or from about −5 to about 10° C.

In embodiments, the invention described herein includes a latex polymer that is a multistage latex polymer having at least a first stage and a second stage or a single stage latex polymer. In an aspect, the monomers of the single stage latex or the monomers of the first stage and second stage of the multistage latex separately and preferably include one or more ethylenically unsaturated monomers. In another aspect, the single stage latex monomers or the first and second stage of the multistage latex separately and preferably includes the one or more polymerization product(s) of (i) ethylenically unsaturated monomers, such as, for example, alkyl and alkoxy (meth)acrylates, vinyl esters of saturated carboxylic acids, monoolefins, conjugated dienes, optionally with (ii) one or more monomers, such as, for example, styrene, methyl methacrylate, butyl acrylate, 2-ethylhexyl acrylate, vinyl acetate, acrylonitrile, vinyl chloride, and the like. In an embodiment, the monomers of the latex polymers optionally include one or more polyfunctional (meth)acrylate monomers. In an embodiment, the monomers also include one or more ethylenically unsaturated carboxy-functional amide monomers, e.g., ureido-functional monomers, such as monomers formed as the product of the reaction between aminoalkyl alkylene urea (e.g., amino ethylene urea, for example) with an ethylenically unsaturated carboxylic acid or anhydride (e.g., maleic anhydride, for example).

Suitable ethylenically unsaturated monomers of the single stage latex or the first and second stage of the multistage latex include, for example, acrylic acid, methacrylic acid, methyl acrylate, ethyl acrylate, propyl acrylate, butyl acrylate, 2-ethylhexyl acrylate, methyl methacrylate, ethylmethacrylate, propylmethacrylate, butyl methacrylate, 2-ethylhexyl methacrylate, hydroxyethyl acrylate, hydroxyethyl methacrylate, hydroxy butyl acrylate, hydroxy butyl methacrylate, glycidyl methacrylate, 4-hydroxy butyl acrylate glycidyl ether, 2-(acetoacetoxy)ethyl methacrylate (AAEM), diacetone acrylamide (DAAM), acrylamide, methacrylamide, methylol (meth)acrylamide, styrene, α-methyl styrene, vinyl toluene, vinyl acetate, vinyl propionate, allyl methacrylate, and mixtures thereof. Preferred monomers include styrene, methyl acrylate, methyl methacrylate, ethyl acrylate, methacrylic acid, DAAM, AAEM, n-butyl acrylate, tert-butyl acrylate, tert-butyl methacrylate, n-butyl methacrylate, esters of itaconic acid, vinyl acetate, 2-ethyl hexyl acrylate, bio-renewable monomers, and the like.

Suitable polyfunctional acrylates include, for example, di-, tri- and tetra-functional acrylates such as dipropylene glycol diacrylate (DPGDA), propoxylated glyceryl triacrylate (GPTA), pentaerythritol tetraacrylate, dipentaerythritol tetraacrylate, mixtures thereof, and the like. Preferred polyfunctional acrylate monomers include pentaerythritol tetraacrylate, dipentaerytrithol tetraacrylate, and the like.

In some embodiments, the latex copolymer is formed of at least 80 wt % of two or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex copolymers (and not factoring any optional seed used).

In some embodiments, the latex copolymer is formed of at least 90 wt % of three or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex copolymers (and not factoring any optional seed used).

Suitable ureido-functional monomers include, for example, monomers with the —NR—(C═O)—NH— functionality, where R may be H, substituted or unsubstituted C₁-C₁₀ alkyl, substituted or unsubstituted C₃-C₆ cycloalkyl or heteroalkyl, and the like. Without being bound by theory, ureido-functional monomers are believed to promote the wet adhesion of the coating compositions and coating and colorant systems described herein to a substrate.

In certain embodiments, latex copolymers (whether single stage, multistage, or gradient Tg) are typically made using seed particles as a nucleating agent for polymerization. Such seed particles may be in the form of inorganic particulate seed (e.g., clay or glass particles), preformed particulate polymer seed (latex or non-latex polymer seed), or particulate seed polymer formed in situ. Polymer seed can be an emulsion polymerized polymer seed, but does not encompass polymeric surfactant. In certain embodiments, seed particles are used in an amount of no more than 10 wt %, or no more than 5 wt %, based on latex polymer solids in the final latex.

Herein, whether inorganic particulate seed, preformed particulate polymer seed, or particulate seed polymer formed in situ, such seed particles will not be deemed to provide a stage of a multistage polymer or to provide a basis for designating a single stage polymer or gradient Tg polymer made using such seed polymer as a multistage polymer.

In certain embodiments, the latex copolymers of the present invention may further include latent crosslinking monomers that possess the ability to further react with a crosslinker at some time after initial formation of the latex copolymer (e.g., during coating cure). The crosslinking reaction can occur through the application of energy, e.g., through heat or radiation. Also, dying can activate the crosslinking polymer through changes in pH, oxygen content, evaporation of solvent or carrier, or other changes that causes a reaction to occur. A variety of chemistries are known in the art to produce crosslinking in latexes. When used, such one or more crosslinking monomers are typically are included in the latex copolymer in an amount of at least about 0.1 wt %, at least about 1.0 wt %, at least about 2 wt %, at least about 2.5 wt %, at least about 3 wt %, at least about 4 wt %, or at least about 5 wt %, based on the weight of the one or more crosslinking monomers relative to the total weight of monomers used to form the latex copolymer. While the amount of such one or more crosslinking monomers may vary widely, typically the one or more crosslinking monomers are present in the latex copolymer in an amount of about 10 wt % or less, about 9 wt % or less, about 8 wt % or less, about 7 wt % or less, about 6 wt % or less, or about 5 wt % or less, based on the weight of the one or more crosslinking monomers relative to the total weight of monomers used to form the latex copolymer.

Suitable examples of latent crosslinking carbonyl-containing monomers include acrolein, methacrolein, diacetone acrylamide, diacetone methacrylamide, 2-butanone methacrylate, formyl styrol, diacetone acrylate, diacetone methacrylate, acetonitrile acrylate, acetoacetoxyethyl methacrylate, acetoacetoxyethyl acrylate and vinylacetoacetate. These monomers normally do not affect crosslinking until during final film formation, for example, when the aqueous polymer emulsion simultaneously contains an appropriate added amount of a polyamine compound as crosslinker. Particularly suitable compounds of this type are the dihydrazides and trihydrazides of aliphatic and aromatic dicarboxylic acids of 2 to 20 carbon atoms. Polyamine compounds useful as crosslinkers for the carboxyl functional groups include those having an average of at least two carbonyl-reactive groups of the formula —NH₂ and carbonyl reactive groups derived from such groups. Examples of useful amine functional groups include R—NH₂, R—O—NH₂, R—O—N—C<, R—NH—C(═O)—O—NH₂, wherein R is alkylene, alicyclic or aryl and may be substituted. Representative useful polyamines include ethylene diamine, isophorone diamine, diethylenetriamine and dibutylenetriamine. In one embodiment of the invention, it is useful to utilize polyhydrazides as the polyamine compounds. Representative useful polyhydrazides include oxalic dihydrazide, adipic dihydrazide, succinic dihydrazide, malonic dihydrazide, glutaric dihydrazide, phthalic or terephthalic dihydrazide and itaconic dihydrazide. Additionally, water-soluble hydrazines such as ethylene-1,2-dihydrazide, propylene-1,3-dihydrazide and butylene-1,4-dihydrazide, can also be used as one of the crosslinking agents.

While not intending to be bound by theory, it is believed that DAAM is an especially useful crosslinking monomer for use in combination with the block resistance additives of the present invention. While not intending to be bound by theory, as evidenced by the data in the Examples section, it is believed that the use of efficacious amounts of the two together in a paint composition (e.g., satin, semi-gloss, or high-gloss paint compositions) can lead to an enhancement in block resistance properties that is more than additive (i.e., synergistic).

In certain embodiments, the latex copolymers of the present invention may further include one or more bio-based monomers. “Bio-based,” as used with respect to monomers herein, refers to monomers that are preferably obtained from bio-renewable olefinically unsaturated monomers. Such bio-renewable olefinically unsaturated monomers have a carbon-14 (C-14) that is significantly higher than olefinically unsaturated monomers derived from fossil fuels. This is because C-14 has a relatively short half-life on the scale of the age of fossil-fuel-based materials. Thus, “bio-renewable” monomers as used herein mean monomers for which the level of C-14 isotope is comparable to the mean level of C-14 in atmospheric CO₂, as measured by ASTM D6866 or having at least about 1.5 dpm/gC (disintegrations per minute per gram carbon), at least 2.5 dpm/gC, or at least 3.0 dpm/gC of C-14, as measured through liquid scintillation counting.

Exemplary such bio-based monomers include esters of itaconic acid, bio-derived (meth)acrylic acid, and alkyl (meth)acrylic acid. In embodiments, bio-based monomers make up at least 20 wt %, at least 30 wt %, or at least 40 wt % of the latex copolymer by weight of all monomers polymerized to form the latex copolymer.

In certain embodiments, the invention described herein includes a latex copolymer that is a multistage latex polymer having at least a first stage and a second stage, the first or second stage of the multistage latex each separately and preferably include about 90 to 99 wt %, more preferably about 94 to 96 wt %, and most preferably about 97 to 98 wt % of one or more ethylenically unsaturated monomers, and preferably up to about 5 wt %, more preferably about 0.05 to 4 wt %, and most preferably about 0.5 to 1.5 wt % of one or more ureido-functional monomers, based on the total weight of the monomers in the first or second stage respectively. For example, in a preferred embodiment, the first stage includes about 65 to 70 wt % methyl methacrylate, 15 to 20 wt % butyl acrylate, 2 to 4 wt % acrylic acid, 2 to 4 wt % DAAM, and about 0.5 to 1.5 wt % ureido-functional monomer. In a preferred embodiment, the second stage includes about 30 to 40 wt % methyl methacrylate, 45 to 55 wt % butyl acrylate, about 2 to 4 wt % DAAM, about 1 to 3 wt % methacrylic acid, and about 0.5 to 1.5 wt % ureido-functional monomer. Examples of suitable such multi-stage latex copolymers are further described, for example, in U.S. Pat. No. 10,647,871.

Examples of suitable commercially available latex copolymer dispersions include the EPS 2720 and EPS 2799 produce available from Engineered Polymer Solutions of Marengo, IL.

In a preferred embodiment, the invention described herein includes a latex copolymer that is a single stage latex. In an aspect, the single stage latex is formed from monomers that include about 20 to 60, preferably 30 to 55 percent by weight of methyl methacrylate; 0 to 40, preferably 10 to 30 percent by weight of 2-ethyl hexyl acrylate; 10 to 60, preferably 15 to 55 percent by weight of butyl acrylate; about 0 to 30, preferably 10 to 20 percent by weight of butyl methacrylate; and about 0 to 10, preferably 1 to 5 percent by weight of methacrylic acid.

The coating compositions of the present invention are preferably latex-based coating compositions. Thus, in preferred embodiments, at least a majority (i.e., more than 50 wt %), more preferably substantially all or all, of the resin solids in the coating compositions are latex copolymers, more preferably DAAM-containing latex copolymers. Typically, the coating compositions include at least 20 wt %, at least 30 wt %, at least 40 wt %, or at least 50 wt % of latex copolymer solids, based on total solids in the coating composition. Certain high gloss deep base paints may include 80 wt % or more of latex copolymers. While the upper amount of latex copolymer included in the coating composition may vary widely (e.g., depending upon the amount of pigment included), typically the coating compositions will include less than 90 wt % latex copolymer solids, based on total solids.

Preferred embodiments of the present invention further comprise a non-fluorinated, non-polymeric additive. As discussed throughout, the additive can impart a variety of desired coating performance properties, including both block resistance and early hot block resistance. The additive may be added to the compositions and coating and colorant systems described below, either directly to the latex copolymer, before or after completion of polymerization, or as “post-adds” to the broader coating compositions or coating and colorant systems. As discussed above, the non-fluorinated, non-polymeric additive is a distinct additive or compound from the emulsifying surfactant employed in making or polymerizing the latex copolymer. In other embodiments, the non-fluorinated, non-polymeric surfactant is not a polymerization surfactant and, in some embodiments, does not facilitate emulsion polymerization of monomers in the aqueous media. The non-fluorinated, non-polymeric additive, in some embodiments, is combined with the latex polymer and any emulsifying surfactants at some time following completion of emulsion polymerization.

In preferred embodiments, the non-fluorinated, non-polymeric additive is present in the coating composition or coating and colorant systems in amounts of at least about 0.05%, at least about 0.10% or at least about 0.15% by weight of total resin solids in the coating composition. In preferred embodiments, the non-fluorinated, non-polymeric additive is present in the coating composition or coating and colorant systems in amounts of no more than about 0.6%, no more than about 0.4%, or no more than about 0.3% by weight of total resin solids in the coating composition. In further embodiments, the non-fluorinated, non-polymeric additive is present in the coating composition in an amount of at least 0.2 pounds (“lb.”) per 100 gallons, at least 0.5 lb. per 100 gallons, or at least 1 lb. per 100 gallons of coating composition. In further embodiments, the non-fluorinated, non-polymeric additive is present in the coating composition in an amount of no more than about 4 lb. per 100 gallons, no more than about 3 lb. per 100 gallons, no more than about 2.5 lb. per 100 gallons, or no more than about 2 lb. per 100 gallons of the coating composition.

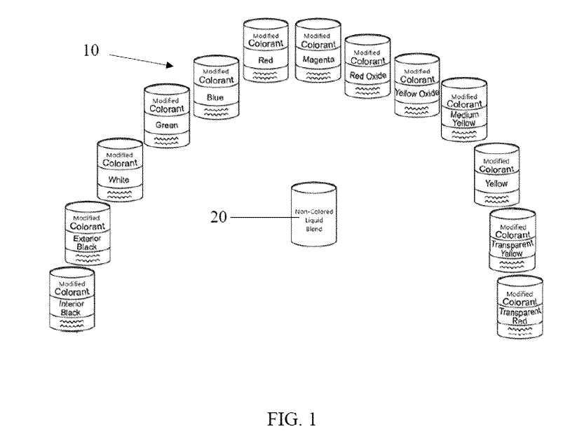

According to some embodiments, the invention is a coating and colorant system comprising an in-store tintable liquid base paint formulation and one or more colorant compositions. The colorant compositions may be added in a factory to pre-tint a base, or may be added using a point-of-sale system that meters colorant into the tintable liquid base paint formulation from a set colorant array to provide a desired color. In these embodiments, the non-fluorinated, non-polymeric additive can be present in the one or more colorants, the in-store tintable liquid base paint formulation, or both. According to further embodiments, the above color array includes a non-colored fluid in addition to one-or more colorants (see FIG. 1 for an example). In such further embodiments, the non-fluorinated, non-polymeric additive can be present in the non-colored fluid to be metered into the in-store tintable liquid base paint formulation to deliver a desired additive concentration in the base paint with limited impact on color, in the one or more colorant, in the in-store tintable liquid base paint formulation, or in a combination thereof. In preferred embodiments, 0 to 25 wt % of the one or more colorants are added to the in-store tintable liquid base paints either in a factory or at point-of-sale to achieve a desired color.

In preferred embodiments, the non-fluorinated, non-polymeric additive is present in the one or more of the colorants of the above coating and colorant systems in amounts of at least about 0.3 wt %, at least about 0.7 wt %, at least about 1.0 wt % by weight of the colorant. In preferred embodiments, the non-fluorinated, non-polymeric additive is present in the one or more of the colorants of the above coating and colorant systems in amounts of no more than about 2.0 wt %, no more than about 2.5 wt %, no more than about 3.0 wt %, or no more than 5.0 wt % by weight of the colorant.

In preferred embodiments, the non-fluorinated, non-polymeric additive is present in the non-colored fluid of the above coating and colorant systems in amounts of at least about 0.3 wt %, at least about 0.7 wt %, at least about 1.0 wt % by weight of the non-colored fluid. In preferred embodiments, the non-fluorinated, non-polymeric additive is present in the non-colored fluid of the above coating and colorant systems in amounts of no more than about 3.0 wt %, no more than about 5.0 wt %, no more than about 10.0 wt %, or no more than 15.0 wt % by weight of the non-colored fluid.

The non-fluorinated, non-polymeric additive preferably includes a salt group, which is preferably an at least partially neutralized acid group. In preferred embodiments, the addictive includes both (i) an acid group that has been at least partially (or fully) neutralized with a base, wherein the acid group includes at least one sulfur or phosphorus atom and (ii) a linear or branched, substituted or unsubstituted alkyl group. In certain embodiments, the alkyl group of the non-fluorinated, non-polymeric additive is fully saturated. In certain embodiments, the non-fluorinated, non-polymeric additive is fully saturated.

Examples of suitable bases for use in at least partially, or fully, neutralizing acid group(s) of the additive include sodium hydroxide, potassium hydroxide, calcium hydroxide, lithium hydroxide, magnesium hydroxide, ammonia, an amine (e.g., diethanolamine, trimethyl amine, dimethylethanol amine, methyldiethanol amine, triethanol amine, ethyl methyl ethanol amine, dimethyl ethyl amine, dimethyl propyl amine, dimethyl 3-hydroxy-1-propyl amine, dimethylbenzyl amine, dimethyl 2-hydroxy-1-propyl amine, diethyl methyl amine, dimethyl 1-hydroxy-2-propyl amine, triethyl amine, tributyl amine, or N-methyl morpholine), or a mixture thereof. In some embodiments, it may be advantageous to use a basic compound for neutralization that is a fugitive base, more preferably a fugitive nitrogen base (e.g., ammonia and primary, secondary, and/or tertiary amines).

In certain embodiments, the non-fluorinated, non-polymeric additive is selected from the salt of one or more alkyl phosphates, alkyl phosphonates, alkyl phosphate esters, alkyl sulfates, alkyl sulfonates, alkyl sulfate esters, or a combination thereof.

In certain embodiments, the non-fluorinated, non-polymeric additive (prior to neutralization with base) comprises an alkyl phosphate ester, wherein the alkyl phosphate ester has the structure:

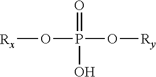

wherein Rx represents a linear or branched alkyl group, Ry represents a linear or branched alkyl group, x represents the number of carbon atoms in the branched or linear alkyl group of Rx, y represents the number of carbon atoms in the branched or linear alkyl group of Ry, and a single coating composition may contain non-fluorinated, non-polymeric additives having different Rx and Ry values. In some embodiments, x ranges from 5 to 10 (i.e., 5, 6, 7, 8, 9, or 10 carbon atoms) and y is 0 (in which case Ry is a hydrogen atom) or ranges from 5 to 10 (i.e., 5, 6, 7, 8, 9, or 10 carbon atoms), and x and y range independently. In some embodiments, neither Rx nor Ry includes any oxygen atoms in its longest carbon chain (e.g., neither Rx nor Ry is alkoxylated). In some embodiments, Rx and Ry include only carbon and hydrogen in their longest carbon chains. In another embodiment, the non-fluorinated, non-polymeric additive is a reaction product of ingredients including 1-pentanol, 1-hexanol, 1-heptanol, 1-octanol, 1-nonanol, or 1-decanol. In one embodiment, Rx and Ry each include 8 carbons, and preferably, the non-fluorinated, non-polymeric additive is a reaction product of ingredients including 1-octanol.

In exemplary embodiments, the non-fluorinated, non-polymeric additive may be an additive from the Stepan STEPCOTE™ multi-functional wetting agent line of products (available from the Stepan Company, Northfield, IL). In exemplary embodiments, the non-fluorinated, non-polymeric additive is selected from STEPCOTE™ W-846, STEPCOTE™ W-849, STEPCOTE™ W-888, STEPCOTE™ W-839, STEPCOTE™ W-843, STEPCOTE™ W-877, STEPCOTE™ W-119, or the B-681 product also from Stepan.

Additional components may be added to the compositions and coating and colorant systems described herein, either directly to the latex copolymer, before or after completion of polymerization, or as “post-adds” to the broader coating compositions or coating and colorant systems.

In an embodiment, coating compositions and coating and colorant systems described herein are substantially free of or include reduced amounts of fluorosurfactants as compared to conventional coatings. As used herein, the term “fluorosurfactant” refers to synthetic organofluorine compounds with one or more fluorine atoms, more typically multiple fluorine atoms. Such compounds can be polyfluorinated, perfluorinated (i.e., fluorocarbons), or partially fluorinated, and typically include a hydrophilic head and a fluorinated/hydrophobic tail.

Fluorosurfactants may be anionic or nonionic. Conventionally used fluorosurfactants include, for example, fluoroalkanes, perfluoroalkanes, their derivatives, and the like. Fluorosurfactants, as used herein, also include short chain fluorinated compounds, such as, for example, C1-C10 fluorinated compounds.

In a preferred aspect, the coating compositions and coating and colorant systems described herein are further substantially free of or contain reduced levels of all compounds containing fluorinated carbon (“fluorine-containing compounds”) as compared to conventional coatings. Such compounds include fluorosurfactants, but also PFOS and PFOA compounds and all compounds containing a carbon-fluorine bond. In a preferred aspect, the coating compositions and coating and colorant systems described herein contain no intentionally added fluorinated carbon compounds. “Intentionally added” fluorinated carbon compounds do not include fluorinated carbon compounds that are present in standard raw materials for coatings and coating and colorant systems and that are not publicly disclosed as being present in the raw materials. In a preferred aspect, the coating compositions and coating and colorant systems described herein are further substantially free of or contain reduced levels of elemental fluorine. As used herein, such “elemental fluorine” does not include fluorine that is present in standard raw materials for coatings and coating and colorant systems and that are not publicly disclosed as being present in the raw materials or fluoride that is present in drinking water.

The coating compositions and coating and colorant systems described herein may include other components or additives, added to either the reaction mixture of monomers used to make the latex copolymer, to the latex copolymer, or to a coating composition or base paint that includes or will include the latex copolymer. Suitable additives are known to those of skill in the art and include, for example, surfactants, open time agents, pH adjustors, initiator and chaser solutions, cross-linking agents, preservatives, defoaming agents, anticorrosive agents, thixotropes, rheological modifiers, matting agents, and the like. The additives may include one or more ingredients added to a paint to modify the properties or enhance paint performance during storage, handling, application and other or subsequent stages. Desirable performance characteristics of a paint formulation include, for example, chemical resistance, hardness, gloss, reflectivity, appearance and/or a combination of such properties and similar other properties. Preferred performance enhancing additives include lacquers, waxes, flatting agents, additives to prevent mar, abrasion, and the like.

Pigments and fillers may also be added to a coating composition (via a pigment grind) to provide a desired opacity, hiding characteristics, or PVC. Without being bound by theory, it is generally understood that lower PVC coatings show higher gloss and lower scrub and block resistance. The coating compositions of the present invention show surprisingly good block and tack resistances for low PVC coatings having higher sheens (satin sheens, semi-gloss sheens, high gloss sheens) such as, for example, coatings having PVCs of about 30% or less, or about 20% or less. In preferred embodiments, the coating composition of the present invention show surprisingly good block resistance and tack resistance for semi-gloss or high gloss coatings having higher gloss ratings (e.g., after seven days of cure) such as, for example, 60-degree gloss ratings of 41 or higher, 50 or higher, 60 or higher, 70 or higher, or 80 or higher.

Pigments may be supplemented with extenders or fillers such as talc, china clay, barytes, carbonates, silicates and mixtures thereof, for example magnesium silicates, calcium carbonate, aluminosilicates, silica and various clays; organic materials including plastic beads (e.g., polystyrene or polyvinyl chloride beads), microspherical materials containing one or more voids, and vesiculated polymer particles (e.g., those discussed in U.S. Pat. Nos. 4,427,835, 4,920,160, 4,594,363, 4,469,825, 4,468,498, 4,880,842, 4,985,064, 5,5157,084, 5,041,464, 5,036,109, 5,409,776, and U.S. Pat. No. 5,510,422). Other exemplary extenders or fillers include EXPANCEL™ 551DE20 acrylonitrile/vinyl chloride expanded particles (from Expancel Inc.), SIL-CEL™ 43 glass micro cellular fillers (from Silbrico Corporation), FILLITE™ 100 ceramic spherical particles (from Trelleborg Fillite Inc.), SPHERICEL™ hollow glass spheres (from Potter Industries Inc.), 3M ceramic microspheres including grades G-200, G-400, G-600, G-800, W-210, W-410, and W-610 (from 3M), 3M hollow microspheres including 3M Performance Additives iM30K (also from 3M), INHANCE™ UH 1900 polyethylene particles (from Fluoro-Seal Inc.), and BIPHOR aluminum phosphate (from Bunge Fertilizantes S.A., Brazil).

In an aspect, the coating compositions or coating and colorant systems described herein may include a coalescing agent that aids in film formation, added to either the reaction mixture of monomers used to make the latex copolymer, to the latex copolymer, or to a coating composition or base paint that includes the latex copolymer. Suitable coalescing agents or coalescent compounds are dispersible in a latex copolymer, coating composition or paint that includes the latex described herein, and facilitate film formation at temperatures of less than about 25° C., and even at temperatures of 5 to 10° C. Preferred coalescing agents are low VOC coalescing agents and have VOC content of less than about 50%, preferably less than about 30%, more preferably, less than about 20%, and most preferably, less than about 15%. Exemplary suitable coalescing agents include low VOC compounds of the type described in detail at least in U.S. Pat. Nos. 6,762,230 and 7,812,079. Other suitable low VOC coalescents include Optifilm (Eastman Chemical, Kingsport TN), Loxanol (Cognis, Kankakee IL, now BASF), Archer RC (ADM, Decator IL), and the like. Conventional coalescing agents such as, Texanol (Eastman Chemical) and the like can also be used, either alone or in combination with other solvents such as, for example, 2-butoxyethanol (butyl cellosolve), diethylene glycol monobutyl ether (butyl carbitol), and the like, provided low VOC levels are maintained in the coating composition or paint.

Although coalescing agents are typically used in paint to aid in film formation, the coating compositions and coating and colorant systems described herein is oftentimes capable of film formation at low levels of coalescent, or even in the absence of coalescing agents, at film-forming temperatures of 25° C. or less, more preferably at temperatures of 10° C. or less. Accordingly, in an aspect, the coalescing agent is an optional ingredient in coating compositions or paints that include the latex described herein, and in a preferred aspect, the coating composition or paint is substantially free, and more preferably, essentially free of coalescing agents. In a preferred aspect, the composition described herein includes no more than about 15 wt %, preferably less than 15 wt %, more preferably less than about 10 wt % coalescing agent.

In an aspect, the coating compositions or coating and colorant systems described herein may include a UV-VIS absorber. Compounds that are suitable for use in the present disclosure as UV-VIS absorbers include ultraviolet absorbers, visible light absorbers, or combinations thereof. These are typically referred to as photoinitiators.

Suitable UV-VIS absorbers are water-insoluble. By this it is meant that the compounds will not dissolve to an appreciable extent (i.e., will not dissolve in an amount of more than 5 wt %) in water at the temperatures typically used for preparing coatings compositions as described herein.

In certain embodiments, suitable UV-VIS absorbers are those compounds capable of absorbing ultraviolet and/or visible radiation within a range of 240-465 nm. For certain embodiments, they are capable of absorbing radiation in the 280-450 nm range. In certain embodiments, suitable visible light absorbers are those compounds capable of absorbing visible radiation within a range of 420-450 nm. In certain embodiments, suitable ultraviolet absorbers are those compounds capable of absorbing UV radiation within a range of 240-400 nm. For certain embodiments, they are capable of absorbing UV radiation in the 280-400 nm range, and for certain embodiments in the 315-375 nm range.

Herein, the UV-VIS (preferably, ultraviolet) absorbers do not form a bond to the latex copolymer, although they are capable of generating a radical through a hydrogen-abstraction mechanism by absorbing UV-VIS (typically, UV) radiation. Although not wishing to be bound by theory, it may be that this results in surface crosslinking of the latex copolymer.

Examples of suitable ultraviolet absorbers include the following: Benzophenone (available from Lamberti, Gallaratte, Italy); Phenylbis(2,4,6-trimethylbenzoyl) phosphine oxide (available under the trade name IRGACURE 819DW from BASF, Florham Park, N.J.); Ethyl-2,4,6-trimethylbenzoylphenylphosphinate (available under the trade name LUCIRIN TPO-L (formerly: LUCIRIN LR 8893) from BASF, Florham Park, N.J.); 2,4,6-trimethylbenzophenone & 4-methylbenzophenone (available as a mixture under the trade name ESACURE TZT from Lamberti, Gallaratte, Italy); 2,2-Dimethoxy-1,2-diphenylethanone (i.e., Benzildimethylketal) (available under the trade name ESACURE KB 1 from Lamberti); 1-Hydroxycyclohexyl phenyl ketone (i.e., a-hydroxy cyclohexylphenylketone) (available under the trade name ESACURE KS 300 from Lamberti); 2-Hydroxy-2-methyl-1-phenyl-1-propanone (available under the trade name ESACURE KL 200 from Lamberti); Polymeric Benzophenone (available under the trade name EBECRYL P39 from Cytec, Woodland Park, N.J.); Isopropylthioxanthone (available under the trade name GENOCURE ITX from Rahn USA, Aurora, IL); Methyl-o-benzoyl-benzoate (available under the trade name GENOCURE MBB from Rahn); Methylbenzoylformate (available under the trade name GENOCURE MBF from Rahn); Benzoin ethyl ether (available from Aldrich. St. Louis, MO); 4′-Ethoxyacetophenone (from Aldrich. St. Louis, MO); and combinations thereof. Other suitable UV-VIS absorbers are available commercially from BASF under the trade designations IRGACURE and LUCERIN. Methyl-o-benzoyl-benzoate is a preferred UV-VIS absorber for, e.g., improving gloss retention and/or dirt pick-up resistance.

The amount of the UV-VIS (preferably, ultraviolet) absorbers present in the coating compositions and coatings and colorant systems of the present disclosure includes an amount that provides the desired result. In certain embodiments, the water-based composition of the present disclosure includes a sufficient amount of the one or more water-insoluble UV-VIS (preferably, ultraviolet) absorbers to improve dirt pick-up resistance by at least 10%, or at least 20%, or at least 30%, or at least 40%, or at least 50%, relative to the same water-based composition without the UV-VIS (preferably, ultraviolet) absorber, based on a change in ΔE values.

A coating discolors when it picks up dirt. ΔE is measured by a spectrophotometer by comparing the paint that is exposed to dirt and the paint that is “clean” of dirt. The difference is expressed as ΔE. ΔE can be measured using a suitable spectrophotometer (e.g., Datacolor Check II Spectrophotometer using CIELab software) following ASTM D2244, Standard Test Method for Calculation of Color Differences from Instrumentally Measured Color Coordinates.

The difference in ΔE's from the “control” paint and the “experimental” paint can then be calculated. The improvement in dirt pick-up resistance can be expressed as a percentage by taking the difference in ΔE divided by the ΔE of the “control” paint.

In certain embodiments, the coating compositions or coatings and colorant systems of the present disclosure include at least 0.1 wt %, or at least 0.3 wt %, or at least 0.5 wt %, of one or more UV-VIS (preferably, ultraviolet) absorbers, based on the weight of total resin solids. In certain embodiments, the water-based compositions of the present disclosure include up to 5.0 wt-%, or up to 3.0 wt-%, or up to 1.5 wt %, or up to 1.0 wt %, of one or more UV-VIS (preferably, ultraviolet) absorbers, based on the weight of total resin solids.

In preferred embodiments, the coating composition described herein is suitable for use in a low-VOC or zero-VOC coating composition or a paint to be colored or tinted to a desired color and finish, such as an in-store tintable base paint, for example. In an aspect, the coating composition or paint may include one or more pigments, including pigments or fillers used to tone or opacify the in-store tintable base paint. Suitable examples of pigments include, without limitation, titanium dioxide white, carbon black, lamp black, black iron oxide, red iron oxide, yellow iron oxide, brown iron oxide (a blend of yellow and red oxide with black oxide), phthalocyanine green, phthalocyanine blue, organic reds (such as naphthol red, quinacridone red and toluidine red), quinacridone magenta, quinacridone violent, DNA orange, and/or organic yellows (such as Hansa yellow), for example.

In a coating and colorant system embodiment, the coating composition, such as a paint, especially a base paint to be colored or tinted at the point-of-sale of a paint of desired color and finish with the addition of one or more colorants. In an aspect, the base paint may be clear (unpigmented) or pigmented prior to being colored or tinted. In an aspect, the base paint is tinted or colored in-store using one or more commercially available colorants. Suitable colorants which can be used in a coating composition or paint formulation include, for example, NovoColor (Color Corp. of America, Rockford, IL) colorants, i.e., zero-VOC colorants compatible with water-based coating compositions as described herein. Preferred colorant compositions include a colorant component, i.e., a pigment dispersed in a liquid phase, a surfactant package that includes a latex-compatible surfactant, a carrier, and other optional additives. Exemplary colorant compositions include single colorant formulations compatible with latex paints, of the kind described in U.S. Pat. Nos. 6,488,760 and 7,659,340. These colorant compositions are uniform and do not require mixing before addition to a base paint formulation, have extended shelf-life, and show viscosity increase of less than about 15 KU, more preferably less than about 10 KU, when stored over an extended period of time at temperatures of about 40° C. to 50° C.

In an aspect, the base paint formulation can be tinted to produce a dark or deeply colored paint. Base paints suitable for use in producing dark/deeply colored finish paints are often referred to as “tint bases”, “clear bases”, “deep bases” or “neutral bases.” For simplicity, such bases herein are referred to as “deep bases.” Deep bases typically include little to no white pigment (e.g., include less than about 1 wt % of TiO₂, if any) to allow for the acceptance of more colorant to maximize color flexibility and enable the production of deeper colors. To produce such dark or deeply colored paint requires a high colorant load. In an aspect, the amount of colorant to be added to the base paint is determined by the desired color and finish (i.e., glossy, semi-gloss, satin, etc.) of the colored paint. Preferably, the paint includes up to about 25 wt % colorant, more preferably about 5 to 15 wt % colorant, and most preferably about 8 to 12 wt % colorant.

Typically, the viscosity of the base paint decreases when the colorant composition is added. A deeply colored paint requires a high colorant load, and therefore, the colored paint will have a lower viscosity and may have poor properties on application to a substrate. Moreover, as many base paints are made to have low or no VOC by using softer polymers, and low or no VOC-containing colorants added to the base paint have a high percentage of non-volatile soft components, it can be difficult to form a hard acrylic film or coating, with good mechanical properties, i.e., block resistance, and scrub resistance, for example. Surprisingly, the coating compositions and coating and colorant systems described herein, when used in a base paint to be tinted to a colored paint, and especially a deeply colored paint, resists softening even at the high colorant load, with a correspondingly high percentage of non-volatile soft components, needed to make a deeply colored paint. Contrary to expectation, paints made using the coating compositions and coating and colorant systems comprising the non-fluorosurfactant, non-polymeric additive described herein provide excellent block resistance while maintaining superior scrub resistance when compared to commercially available latex polymers. The compositions further maintain comparable or better such characteristics as compared to coating compositions that employ the use of fluorosurfactants for a similar purpose.

In contravention of industry bias, when used for paint applied at high temperatures and/or in very humid environments, the coating compositions and coating and colorant systems described herein display excellent performance characteristics, with optimal scrub resistance and tack resistance, along with superior block resistance relative to formulations made using commercially available latex polymers.

In preferred embodiments, paints made according to the coating compositions and coating and colorant systems described herein demonstrate excellent block resistance. Block resistance is measured by a standard test as described below, and block ratings are assigned on a scale from 0 to 10, where a rating of 0 corresponds to very poor block resistance, and a rating of 10 corresponds to excellent block resistance. In an aspect, the paints described herein show 1-day and 7-day block ratings of preferably at least 6, more preferably at least 7, and most preferably at least 8.

Good early hot block resistance is difficult to achieve for semi-gloss and high gloss bases and finish paints, particularly in the absence of fluorosurfactant. It is especially challenging to achieve good early hot block resistance for low VOC such coating compositions, particularly low VOC deep bases and highly colored finish paints. In preferred embodiments, paints made according to the coating compositions and coating and colorant systems described herein demonstrate good early hot block resistance, with 1-hour and 4-hour early hot block ratings of preferably at least 6, more preferably at least 7, and most preferably at least 8. In some embodiments, semi-gloss and high-gloss deep bases and deeply colored architectural finish paints described herein exhibit early hot block resistance ratings (after 1-hour and/or 4-hours) of at least about 6. In some embodiments, semi-gloss and high-gloss white bases and white architectural finish paints described herein exhibit early hot block resistance ratings (after 1-hour and/or 4-hours) of at least about 8.

In an embodiment, paints made according to the coating compositions and coating and colorant systems described herein demonstrate superior scrub resistance, when compared to commercially available formulations. Scrub resistance is measured by a standard test as described below. The film is cured for seven (7) days, and scrub resistance is reported as a number of scrubs applied before the film failed, i.e., scrubbed off the substrate surface. In an aspect, the paints described herein display scrub resistance of at least about 800 scrubs, more preferably at least about 1000, and most preferably at least about 1200.

### ILLUSTRATIVE EMBODIMENTS

Embodiment 1. An aqueous coating composition comprising:
a latex copolymer;
a carrier fluid; and
a non-fluorinated, non-polymeric additive that preferably includes (i) an acid group that has been neutralized with a base, wherein the acid group includes at least one sulfur or phosphorus atom and (ii) a linear or branched, substituted or unsubstituted alkyl group.

Embodiment 2. The coating composition of the preceding embodiment, wherein the non-fluorinated, non-polymeric additive is selected from the salt of one or more alkyl phosphates, alkyl phosphonates, alkyl phosphate esters, alkyl sulfates, alkyl sulfonates, alkyl sulfate esters, or a combination thereof.

Embodiment 3. The coating composition of the preceding embodiment, wherein the alkyl group of the non-fluorinated, non-polymeric additive is fully saturated.

Embodiment 4. The coating composition of the preceding embodiment, wherein the non-fluorinated, non-polymeric additive is fully saturated.

Embodiment 5. The coating composition of the preceding embodiment, wherein the non-fluorinated, non-polymeric additive is added to the coating composition following polymerization of the latex copolymer.

Embodiment 6. The coating composition of any of the preceding embodiments, wherein the non-fluorinated, non-polymeric additive comprises an alkyl phosphate ester, wherein the alkyl phosphate ester has the structure:

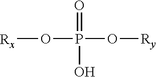

wherein Rx represents a linear or branched alkyl group, Ry represents a linear or branched alkyl group, x represents the number of carbon atoms in the branched or linear alkyl group of Rx, y represents the number of carbon atoms in the branched or linear alkyl group of Ry, and a single coating composition may contain non-fluorinated, non-polymeric additives having different Rx and Ry values.

Embodiment 7. The coating composition of the immediately preceding embodiment, wherein x ranges from 5 to 10 (i.e., 5, 6, 7, 8, 9, or 10 carbon atoms) and wherein y is 0 (in which case Ry is a hydrogen atom) or ranges from 5 to 10 (i.e., 5, 6, 7, 8, 9, or 10 carbon atoms).

Embodiment 8. The coating composition of embodiment 6 or 7, wherein neither Rx nor Ry includes any oxygen atoms in its longest carbon chain (e.g., neither Rx nor Ry is alkoxylated).

Embodiment 9. The coating composition of embodiment 6 or 7, wherein Rx and Ry only include carbon and hydrogen atoms in the backbone of the longest chain.

Embodiment 10. The coating composition of embodiment 6 or 7, wherein Rx and Ry include only carbon and hydrogen atoms.

Embodiment 11. The coating compositions of any of the preceding embodiments, wherein the non-fluorinated, non-polymeric additive is present in the coating composition in an amount of at least about 0.05%, at least about 0.10% or at least about 0.15% by weight of total resin solids in the coating composition.

Embodiment 12. The coating compositions of any of the preceding embodiments wherein the non-fluorinated, non-polymeric additive is present in the coating composition in an amount of no more than about 0.6%, no more than about 0.4%, or no more than about 0.3% by weight of total resin solids in the coating composition.

Embodiment 13. The coating compositions of any of the preceding embodiments, wherein the non-fluorinated, non-polymeric additive is present in the coating composition in an amount of at least 0.2 lb. per 100 gallons, at least 0.5 lb. per 100 gallons, or at least 1 lb. per 100 gallons of coating composition.

Embodiment 14. The coating compositions of any of the preceding embodiments, wherein the non-fluorinated, non-polymeric additive is present in the coating composition in an amount of no more than about 4 lb. per 100 gallons, no more than about 3 lb. per 100 gallons, no more than about 2.5 lb. per 100 gallons, or no more than about 2 lb. per 100 gallons of the coating composition.

Embodiment 15. The coating compositions of any of the preceding embodiments, wherein the non-fluorinated, non-polymeric additive has a number average molecular weight of at least about 100, at least about 150, at least about 175, or at least about 200.

Embodiment 16. The coating compositions of any of the preceding embodiments, wherein the non-fluorinated, non-polymeric additive has a number average molecular weight of no more than about 800, no more than about 500, no more than about 375.

Embodiment 17. The coating compositions of any of the preceding embodiments, wherein the base is selected from sodium hydroxide, potassium hydroxide, calcium hydroxide, lithium hydroxide, magnesium hydroxide, ammonia, an amine or combinations thereof.

Embodiment 18. A coating and colorant system, wherein the coating and colorant system comprises:
an in-store tintable liquid base paint formulation that is a coating composition according to any preceding embodiment; and
about 0 to 25 wt % of one or more colorant compositions which colorants are added to the base paint formulation at a point-of-sale to achieve a desired color.

Embodiment 19. The coating and colorant system of the immediately preceding embodiment, wherein the one or more colorant compositions have a volatile organic content (VOC) of less than about 5 wt %.

Embodiment 20. The coating and colorant system of any of embodiments 18 or 19, wherein the one or more colorant compositions are selected from an array of colorants including at least white, carbon black, red, green, yellow oxide and blue colorants, and the non-fluorinated, non-polymeric additive is present in at least the carbon black and yellow oxide colorants.

Embodiment 21. The coating and colorant system of any of embodiments 18-20, wherein the coating and colorant system further comprises a non-colored fluid that comprises a carrier fluid and the non-fluorinated, non-polymeric additive and wherein the non-colored fluid can be metered into the tintable liquid base paint formulation to achieve a desired coating and colorant system concentration of the non-fluorinated, non-polymeric additive, as needed.

Embodiment 22. The coating and colorant system of the immediately preceding embodiment, wherein the carrier fluid of the non-colored fluid is water and wherein the non-colored fluid further comprises a humectant, a thickener, an additional surfactant, a dispersant, and a preservative.

Embodiment 23. A coating and colorant system comprising:
a coating composition that is an in-store tintable liquid base paint formulation that comprises a latex copolymer and a carrier fluid; and
about 0 to 25 wt % of one or more colorant compositions which colorants are added to the base paint formulation at a point-of-sale to achieve a desired color, wherein the colorants comprise a non-fluorinated, non-polymeric additive that includes (i) an acid group that has been neutralized with a base, wherein the acid group includes at least one sulfur or phosphorus atom and (ii) a linear or branched, substituted or unsubstituted alkyl group.

Embodiment 24. The coating and colorant system of embodiment 23, wherein the non-fluorinated, non-polymeric additive is selected from alkyl phosphates, alkyl phosphonates, alkyl phosphate esters, alkyl sulfates, alkyl sulfonates, alkyl sulfate esters, or combinations thereof.

Embodiment 25. The coating and colorant system of any of embodiments 23-24, wherein the non-fluorinated, non-polymeric additive (prior to neutralization with base) comprises an alkyl phosphate ester, wherein the alkyl phosphate ester has the structure:

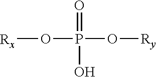

wherein Rx represents a linear or branched alkyl group, Ry represents a linear or branched alkyl group, x represents the number of carbon atoms in the branched or linear alkyl group of Rx, y represents the number of carbon atoms in the branched or linear alkyl group of Ry, and a single coating composition may contain non-fluorinated, non-polymeric additives having different Rx and Ry values.

Embodiment 26. The coating and colorant system of any of embodiments 23-25, wherein x ranges from 5 to 10 (i.e., 5, 6, 7, 8, 9, or 10 carbon atoms) and wherein y is 0 (in which case Ry is a hydrogen atom) or ranges from 5 to 10 (i.e., 5, 6, 7, 8, 9, or 10 carbon atoms).

Embodiment 27. The coating composition of embodiment 25 or 26, wherein neither Rx nor Ry includes any oxygen atoms in its longest carbon chain (e.g., neither Rx nor Ry is alkoxylated).

Embodiment 28. The coating composition of embodiment 25 or 26, wherein Rx and Ry only include carbon atoms in the backbone of the longest chain.

Embodiment 29. The coating composition of embodiment 25 or 26, wherein Rx and Ry include only carbon and hydrogen atoms.

Embodiment 30. The coating and colorant system of any of embodiments 23-29, wherein the non-fluorinated, non-polymeric additive is present in one or more of the colorant compositions in an amount of at least about 0.3 wt %, at least about 0.7 wt %, at least about 1.0 wt % by weight of the colorant composition.

Embodiment 31. The coating and colorant system of any of embodiments 23-30, wherein the non-fluorinated, non-polymeric additive is present in one or more of the colorant compositions in an amount of no more than about 2.0 wt %, no more than about 2.5 wt %, no more than about 3.0 wt %, or no more than 5.0 wt % by weight of the colorant composition.

Embodiment 32. The coating and colorant system of any of embodiments 23 to 31, wherein the one or more colorant compositions are present in the coating and colorant system in an amount of at least about 0.5 wt % and the in-store, liquid tintable base paint formulation, when tinted with the one or more colorant compositions contains at least about 0.2 lb., at least about 0.5 lb., at least about 1 lb. of the non-fluorinated, non-polymeric additive per 100 gallons of the tinted base paint formulation.

Embodiment 33. The coating and colorant system of any of embodiments 23 to 32, wherein the one or more colorant compositions are present in the coating and colorant system in an amount of at least about 0.5 wt % and the in-store, liquid tintable base paint formulation, when tinted with the one or more colorant compositions contains no more than about 4 lb., no more than about 3 lb., no more than about 2.5 lb., or no more than about 2 lb. of the non-fluorinated, non-polymeric additive per 100 gallons of the coating composition.

Embodiment 34. The coating and colorant system of any of embodiments 23 to 33, wherein the one or more colorant compositions have a volatile organic content (VOC) of less than about 5 wt %, less than about 4 wt %, or less than about 3 wt % as measured according to ASTM D6886-18.

Embodiment 35. The coating and colorant system of any of embodiments 23 to 34, wherein the one or more colorant compositions are selected from an array of colorants including at least white, carbon black, red, green, yellow oxide and blue colorants, and the non-fluorinated, non-polymeric additive is present in at least the carbon black and yellow oxide colorants.

Embodiment 36. The coating and colorant system of any of embodiments 23 to 35, wherein the coating and colorant system further comprises a non-colored fluid that comprises a carrier fluid and the non-fluorinated, non-polymeric additive, and the non-colored fluid can be metered into the tintable liquid base paint formulation to achieve a desired coating and colorant system concentration of the non-fluorinated, non-polymeric additive, as needed.

Embodiment 37. The coating and colorant system of the immediately preceding embodiment, wherein the carrier fluid of the non-colored fluid is water and wherein the non-colored fluid further comprises a humectant, a thickener, an additional surfactant, a dispersant, and a preservative.

Embodiment 38. The coating compositions of any of embodiments 23 to 37, wherein the non-fluorinated, where in the base is selected from sodium hydroxide, potassium hydroxide, or combinations thereof.

Embodiment 39. The coating composition or coating and colorant system of any preceding embodiment, wherein the latex copolymer solids are 20 to 80 percent by weight of the overall solids of the coating composition.

Embodiment 40. The coating composition or coating and colorant system of any preceding embodiment, wherein the latex copolymer is a multistage latex comprising a first stage formed from first stage monomers and a second stage formed from second stage monomers, and optionally one or more additional stages.

Embodiment 41. The coating composition or coating and colorant system of embodiment 40, wherein a calculated Tg of the first stage is at least 20° C., at least 30° C., at least 35° C., at least 40° C., or at least 50° C. different than a calculated Tg of the second stage.

Embodiment 42. The coating composition or coating and colorant system of embodiment 40 or 41, wherein at least one stage has a calculated Tg of −35° C. to 20° C.

Embodiment 43. The coating composition or coating and colorant system of embodiment 42, wherein the other of the first and second stages has a calculated Tg of from 0 to 120° C.

Embodiment 44. The coating composition or coating and colorant system of any of embodiments 40-43, wherein the first stage is at least about 20 wt %, at least about 40 wt %, at least about 60 wt %, at least about 70 wt %, or at least about 80 wt % of the total multistage latex weight.

Embodiment 45. The coating composition or coating and colorant system of any of embodiments 40-44, wherein the second stage is at least about 20 wt %, at least about 40 wt %, at least about 60 wt %, at least about 70 wt %, or at least about 80 wt % of the total multistage latex weight.

Embodiment 46. The coating composition or coating and colorant system of any of embodiments 40-45, wherein the first stage forms a core and the second stage forms a shell surrounding the first stage core, and wherein areas of the second stage shell may overlap with the first stage core.

Embodiment 47. The coating composition or coating and colorant system of any of embodiments 40-45, wherein the second stage forms a core and the first stage forms a shell surrounding the second stage core, and wherein areas of the first stage shell may overlap with the second stage core.

Embodiment 48. The coating composition or coating and colorant system of any of embodiments 40-47, wherein the each of the first stage monomers and the second stage monomers comprise methyl (meth)acrylate and n-butyl acrylate, and one or both of the first and second stage monomers further comprise (meth)acrylic acid.

Embodiment 49. The coating composition or coating and colorant system of any of embodiments 1 to 39, wherein the latex copolymer comprises a gradient Tg polymer.

Embodiment 50. The coating composition or coating and colorant system of any of embodiments 1 to 39, wherein the latex copolymer is a single stage latex.

Embodiment 51. The coating composition or coating and colorant system of embodiment 50, wherein the latex copolymer is formed from monomers comprising, as a percentage of a total monomer weight of the latex copolymer:
30-55 wt % methyl methacrylate;
0-40 wt % 2-ethyl hexyl acrylate;
15-55 wt % n-butyl acrylate;
0-30 wt % n-butyl (meth)acrylate; and
optionally, 30-55 wt % styrene.

Embodiment 52. The coating composition or coating and colorant system of any preceding embodiment, wherein the coating compositions or coating and colorant system are capable of forming a film at a temperature of 4° C. or less.

Embodiment 53. The coating composition or coating and colorant system of any of embodiments 1-51, wherein the coating compositions or coating and colorant systems are capable of forming a film at a temperature of 10° C. or less in the absence of a separate coalescing agent.

Embodiment 54. The coating composition or coating and colorant system of any of embodiments 1-51, wherein the coating compositions or coating and colorant systems further include no more than about 10 wt % of a coalescing agent as percentage of the total resin solids weight in the coating composition, and the compositions are capable of forming a film at a temperature of 20° C. or less.

Embodiment 55. The coating composition or coating and colorant system of any preceding embodiment, wherein the latex copolymer is formed from monomers including one or more latent crosslinking monomers.

Embodiment 56. The coating composition or coating and colorant system of embodiment 55, wherein the one or more latent crosslinking monomers comprise 2-(acetoacetoxy)ethyl (meth)acrylate, diacetone acrylamide, or a combination thereof.

Embodiment 57. The coating composition or coating and colorant systems of embodiment 56, wherein a sum of all 2-(acetoacetoxy)ethyl (meth)acrylate and diacetone acrylamide monomers is at least about 0.5 wt %, at least about 0.7 wt %, at least about 1.0 wt %, or at least about 2 wt % as a percentage of a weight of all monomers making up the latex copolymer.

Embodiment 58. The coating composition or coating and colorant systems of embodiment 56 or 57, wherein a sum of all 2-(acetoacetoxy)ethyl (meth)acrylate and diacetone acrylamide monomers is no more than about 6.0 wt %, no more than about 5.5 wt %, no more than about 5.0 wt %, or no more than about 4.0 wt % as a percentage of a weight of all monomers making up the latex copolymer.

Embodiment 59. The coating composition or coating and colorant system of any preceding embodiment, wherein the latex copolymer is formed of at least 80 wt %, at least 85 wt-%, or at least 90 wt-% of one or more, two or more, three or more, four or more, or five or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid.

Embodiment 60. The coating composition or coating and colorant system of any preceding embodiment, wherein the latex copolymer is formed of at least 20 wt % of one or more bio-based monomers having at least 1.5 dpm/gC of carbon-14.

Embodiment 61. The coating composition or coating and colorant system of any preceding embodiment, wherein the latex copolymer is formed of about 0.1 wt % to 2 wt % or 0.5 wt % to 1.5 wt % wet adhesion monomers as a percentage of the weight of all monomers in the latex copolymer.

Embodiment 62. The coating composition or coating and colorant system according to the immediately preceding embodiment, wherein the wet adhesion monomers are selected from ureido monomers, amine functional monomers, and combinations thereof.

Embodiment 63. The coating composition or coating and colorant system of any preceding embodiment, wherein the coating composition or coating and colorant system comprises from 10 to 40 percent polymer solids.

Embodiment 64. The coating composition or coating and colorant system of any preceding embodiment, wherein the coating composition further comprises one or more pigments.

Embodiment 65. The coating composition or coating and colorant system of the immediately preceding embodiment, wherein the one or more pigments comprise titanium dioxide.

Embodiment 66. The coating composition or coating and colorant system of any of embodiments 64 and 65, wherein the coating has a PVC of 40% or less, 30% or less, or 20% or less.

Embodiment 67. The coating composition or coating and colorant system of any of embodiments 64-66, wherein the coating has a PVC of 0% or more, 5% or more, 10 or more, or 18 or more.

Embodiment 68. The coating composition or coating and colorant system of any previous embodiment, wherein the coating composition further comprises an additive package comprising one or more of a thickener, a mildewcide, a defoamer, an additional surfactant, a filler, and a coalescent.

Embodiment 69. The coating composition or coating and colorant system of any preceding embodiment, wherein the latex copolymer has a VOC content of 5 g VOC or less or 1 g VOC or less per 100 g of latex copolymer solids.

Embodiment 70. The coating composition or coating and colorant system of any preceding embodiment, wherein the coating composition has a VOC content of 50 g VOC or less, 25 g VOC or less, or 5 g VOC or less per L coating composition.

Embodiment 71. The coating composition or coating and colorant system of any preceding embodiment, wherein a cured coating formed form the coating composition or coating and colorant system has a satin sheen or higher than satin sheen (e.g., semi-gloss or high gloss).

Embodiment 72. The coating composition or coating and colorant system of any preceding embodiment, wherein a cured coating formed form the coating composition or coating and colorant system has a 60-degree gloss rating of 18 or higher, 20 or higher, 30 or higher, 41 or higher, 50 or higher, 60 or higher, 70 or higher, or 80 or higher.

Embodiment 73. The coating composition or coating and colorant system of any preceding embodiment, wherein the coating composition or coating and colorant system contains no intentionally added fluorine-containing compounds.

Embodiment 74. The coating composition or coating and colorant system of any of embodiments 1-72, wherein the latex copolymer contains no intentionally added fluorine-containing compounds.

Embodiment 75. The coating composition or coating and colorant system of any of embodiments 1-72, wherein the coating composition or coating and colorant system contain less than 0.01 wt % fluorosurfactants as a percentage of the total coating composition weight or coating and colorant system weight, if any.

Embodiment 76. The coating composition or coating and colorant system of any of embodiments 1-72, wherein the coating composition or coating and colorant system each contain less than 1000 parts per billion (ppb), less than 100 ppb, less than 25 ppb, or less than 1 ppb of fluorine-containing compounds.

Embodiment 77. The coating composition or coating and colorant system of any of embodiments 1-72, wherein the coating composition or coating and colorant system each contain less than 1000 parts per billion (ppb), less than 100 ppb, less than 25 ppb, or less than 1 ppb of compounds containing perfluorinated moieties.

Embodiment 78. The coating composition or coating and colorant system of any of embodiments 1-72, wherein the coating composition or coating and colorant system each contain less than 1000 parts per billion (ppb), less than 100 ppb, less than 25 ppb, or less than 1 ppb elemental fluorine as it occurs in all chemical species in the coating composition or coating and colorant system, if any is present.

Embodiment 79. The coating composition or coating and colorant system of any preceding embodiment, wherein the coating composition further comprises one or more UV-VIS absorbers capable absorbing radiation within a range of 240-465 nm (e.g., benzophenone or a substituted benzophenone).

Embodiment 80. The coating composition or coating and colorant system of the immediately preceding embodiment, wherein the UV-VIS absorbers are present in the coating composition in an amount of at least 0.1 wt % based on the weight of polymer solids in the coating composition.

Embodiment 81. The coating composition or coating and colorant system of embodiment 79 or 80, wherein the UV-VIS absorber is selected from the group of benzophenone, polymeric benzophenone, phenylbis(2,4,6-trimethylbenzoyl) phosphine oxide, ethyl-2,4,6-trimethylbenzoylphenylphosphinate, 2,4,6-trimethylbenzophenone, 4-methylbenzophenone, 2,2-dimethoxy-1,2-diphenylethanone, 1-hydroxycyclohexyl phenyl ketone, 2-hydroxy-2-methyl-1-phenyl-1-propanone, isopropylthioxanthone, methyl-o-benzoyl-benzoate, methylbenzoylformate, benzoin ethyl ether, 4′-ethoxyacetophenone, and combinations thereof.

Embodiment 82. The coating composition or coating and colorant system of any of embodiments 79-81, wherein the UV-VIS absorber is methyl-o-benzoyl-benzoate.

Embodiment 83. The coating composition or coating and colorant system of any preceding embodiment, wherein the coating compositions further comprise a low VOC coalescent.

Embodiment 84. The coating composition or coating and colorant system of the immediately preceding embodiment, wherein the low VOC coalescent comprises bis(2-ethylhexyl) maleate, bis(2-ethylhexyl) adipate, bis(2-ethylhexyl) azelate, isodecyl benzoate, tri(ethylene glycol)bis(2-ethylhexanoate), tetra(ethylene glycol)bis(2-ethylhexanoate), tributyl citrate, octyl benzoate, di(ethylene glycol)dibenzoate, octadecenoic acid methyl ester, oleic acid monoester of propylene glycol, or a mixture thereof.

Embodiment 85. The coating composition or coating and colorant system of any of embodiments 83-84, wherein low VOC coalescent is present in an amount of 1 wt % to 10 wt %, based on total resin solids in the coating composition.

Embodiment 86. The coating composition or coating and colorant system of any preceding embodiment, wherein the coating composition or coating and colorant system has a viscosity of 85 to 120 Krebs Units as measured by a Stormer Electronic Viscometer Model KU1+.

Embodiment 87. The coating composition or coating and colorant system of any preceding embodiment, wherein the coating composition or coating and colorant system has a viscosity of 90 to 110 Krebs Units as measured by a Stormer Electronic Viscometer Model KU1+.

Embodiment 88. The coating composition or coating and colorant system of any preceding embodiment, wherein when the coating composition or coating and colorant system is coated onto an article to form a cured coating, the cured coating yields a block resistance rating of at least 6.

Embodiment 89. The coating composition or coating and colorant system of any preceding embodiment, wherein when the coating composition (e.g., a semi-gloss or high-gloss deep base or deeply colored finish paint) or coating and colorant system is coated onto an article to form a cured coating, the cured coating yields an early hot block resistance rating of at least 6 (after one or both of 1-hour or 4-hour cure times).

Embodiment 90. The coating composition or coating and colorant system of any preceding embodiment, wherein when the coating composition (e.g., a semi-gloss or high-gloss white base or finish paint) or coating and colorant system is coated onto an article to form a cured coating, the cured coating yields an early hot block resistance rating of at least 8 (after one or both of 1-hour or 4-hour cure times).

Embodiment 91. The coating composition or coating and colorant system of any preceding embodiment, wherein the coating composition or coating and colorant system when applied to a black mylar substrate and allowed to cure for 1 week at ambient temperature to achieve an average dry coating thickness of 2.6 mil has a scrub resistance of at least 600 scrubs.

Embodiment 92. The coating composition or coating and colorant system of any preceding embodiment, wherein when the coating composition or coating and colorant system when applied to a black mylar substrate and allowed to cure for 1 week at ambient temperature to achieve an average dry coating thickness of 2.6 mil has a scrub resistance of at least 1000 scrubs.

Embodiment 93. The coating composition or coating and colorant system of any preceding embodiment, wherein when the coating composition or coating and colorant system is coated onto an article to form a cured coating, the cured coating exhibits an early pendulum hardness of at least 400, at least 1000, at least 1300, at least 1900, or at least 2100 over an initial curing period of seven days.

Embodiment 94. A coated article, wherein the coated article is formed from the coatings compositions or coating and colorant systems of any of the preceding embodiments coated and cured over an article.

Embodiment 95. The coated article of the immediately preceding claim, wherein the coating on the coated article forms an interface with the article and an interface with ambient air, and the non-fluorinated, non-polymeric additive resides primarily at the interface with ambient air formed by the coating.

The invention is illustrated by the following examples. It is to be understood that the particular examples, materials, amounts, and procedures are to be interpreted broadly in accordance with the scope and spirit of the inventions as set forth herein. Unless otherwise indicated, all parts and percentages are by weight and all molecular weights are weight average molecular weight. Unless otherwise specified, all chemicals used are commercially available from, for example, Sigma-Aldrich, St. Louis, Missouri.

### EXAMPLES

Unless indicated otherwise, the following test methods and compositions were utilized in the Examples that follow.

### Scrub Resistance

The scrub resistance of the paint formulations is tested using ASTM D2486-96 (Standard Test Method for Scrub Resistance of Wall Paints).

### Hot Block Resistance

The block resistance of the paint formulations is tested using ASTM D4946-89 (Standard Test Method for Blocking Resistance of Architectural Paints) and conducted at 50° C. with ratings assessed after 1 day, 3 days, and 7 days of cure time.

### Early Hot Block Resistance

Early hot block resistance of paint formulations is tested by the same means as those used for hot block resistance, but the one kilogram weight is only applied for 15 minutes (instead of 30), and ratings assessed after 1 hour and 4 hours of cure time.

### Examples 1-4 Polymer Composition

Examples 1-4 use the following two-stage polymer composition: in the polymer used in Examples 1-4, the first stage includes about 65 to 70 wt % methyl methacrylate, 15 to 20 wt % butyl acrylate, 1 to 3 wt % methacrylic acid, 2 to 4 wt % DAAM, and about 0.5 to 1.5 wt % ureido-functional monomer. The second stage includes about 30 to 40 wt % methyl methacrylate, 45 to 55 wt % butyl acrylate, about 2 to 4 wt % DAAM, about 1 to 3 wt % methacrylic acid, and about 0.5 to 1.5 wt % ureido-functional monomer. The monomers for each of the stages were emulsion polymerized in the presence of a suitable anionic emulsifying surfactant (either the Certipol FES 32 product from Kensing which is a sodium lauryl ether sulfate or an emulsifying surfactant similar to the Rhodafac RS-610 product available from Syensqo, which is polyoxyethylene tridecyl ether phosphate, ammonium salt). In addition, the polymer composition included a corresponding amount of adipic dihydrazide (ADH) for the amount of DAAM (e.g., slightly less than stoichiometric amount of ADH relative to DAAM). The two-stage polymer composition included about 20 to about 40 wt % of the first stage and about 60 to about 80 wt % of the second stage.

Example 1: White High-Gloss Formulation: A 100-gallon formulation of a white high-gloss paint having a 60-degree gloss rating of at least 70 (after 7 days) was prepared using the ingredients listed in Table 1, with the specific tradename products being examples of suitable such ingredients. The polymer in Table 1 is a multistage latex composition prepared by a sequential monomer feed process as described above and including 0.3 wt % (with respect to the total latex weight) of STEPCOTE™ W-877 non-fluorinated, non-polymeric phosphate ester additive (available from Stepan Company, Northbrook, IL), having a non-substituted, linear alkyl chain, added at the conclusion of polymerization of the latex. According to publicly accessible manufacturer literature STEPCOTE™ W-877 is a (1-octanol/phosphorus pentoxide) potassium salt, potassium octyl phosphate reaction product.

TABLE 1
High Gloss Formulation 1

| Raw Material | Amount (lbs) |
|---|---|
| Water | 159.8 |
| Dispersant (DISPERBYK 190 from BYK) | 12.0 |
| Surfactant (TERGITOL 15-S-9 from Dow) | 2.0 |
| Defoamer (BYK 024 from BYK) | 1.0 |
| Pigment (Ti-PURE R-706 from Chemours) | 225.0 |
| Polymer | 584.7 |
| Coalescent (EPS 9147 from Engineered Polymer | 25.5 |
| Solutions) | |
| Defoamer (BYK 024 from BYK) | 1.0 |
| Neutralizing Agent (30% ammonium hydroxide) | 1.0 |
| High-shear Thickener (ACRYSOL RM-2020NPR | 18.0 |
| from Dow) | |
| Low-shear Thickener (ACRYSOL RM-8W from | 1.0 |
| Dow) | |
| Biocide (POLYPHASE 663 from Troy Corporation) | 10.0 |
| Total | 1041.0 |

Comparative Example 1-A: For Comparative Example 1-A, in place of the 0.3 wt % STEPCOTE™ W-877 additive, a fluorosurfactant, Thetawet FS-8250 (available from Innovative Chemical Technologies, Inc., Cartersville, GA), was added to the formula of Example 1 in an amount of 0.15 wt % (with respect to the total latex weight) to form a positive control.

Example 2: Clear High-Gloss Formulation: A 100-gallon formulation of a clear high-gloss base paint having a 60-degree gloss rating (after 7 days) of at least 70 was prepared using the ingredients shown in Table 2. The polymer in Table 2 is a multistage latex composition prepared by a sequential monomer feed process as described above, and including at least a first stage and a second stage and 0.3 wt % (with respect to the total latex weight) STEPCOTE™ W-877 additive, added at the conclusion of polymerization of the latex.

TABLE 2
Clear High Gloss Formulation 2

| Raw Material | Amount (lbs) |
|---|---|
| Water | 252.8 |
| Polymer | 549.8 |
| Surfactant | 2.0 |
| Defoamer | 2.0 |
| Defoamer | 1.0 |
| Coalescent | 13.3 |
| Neutralizing Agent | 1.0 |
| High-Shear Thickener | 26.0 |
| Low-Shear Thickener | 10.0 |
| Biocide | 10.0 |
| Biocide | 1.5 |
| Total | 869.4 |

Comparative Example 2-A: For Comparative Example 2-A, in place of the 0.3 wt % STEPCOTE™ W-877 additive, a fluorosurfactant, Thetawet FS-8250 (available from Innovative Chemical Technologies, Inc., Cartersville, GA), was added to the formula of Example 2 in an amount of 0.15 wt % (with respect to the total latex weight) to form a positive control.

Example 3: White Semi-Gloss Formulation: A 100-gallon formulation of a white high-gloss paint having a 60-degree gloss rating (after 7 days) of about 64 was prepared using the ingredients listed in Table 3. The polymer in Table 3 is a multistage latex composition prepared by a sequential monomer feed process as described above and including at least a first stage and a second stage and 0.3 wt % (with respect to the total latex weight) STEPCOTE™ W-877 additive, added at the conclusion of polymerization of the latex.

TABLE 3
Semi-Gloss Formulation 3

| Raw Material | Amount (lbs) |
|---|---|
| Water | 172.0 |
| Dispersant | 10.0 |
| Surfactant | 2.0 |
| Defoamer | 2.0 |
| Pigment | 250.0 |
| Pigment | 10.0 |
| Polymer | 554.5 |
| Coalescent | 24.2 |
| Defoamer | 1.0 |
| Neutralizing Agent | 1.0 |
| Neutralizing Agent | 10.0 |
| High-shear Thickener | 15.0 |
| High-shear Thickener | 3.0 |
| Low-shear Thickener | 0.8 |
| Biocide | 10.0 |
| Biocide | 3.0 |
| Total | 1068.5 |

Comparative Example 3-A: For Comparative Example 3-A, in place of the 0.3 wt % STEPCOTE™ W-877 additive, a fluorosurfactant, Thetawet FS-8250 (available from Innovative Chemical Technologies, Inc., Cartersville, GA) was added to the formula of Example 3 in an amount of 0.15 wt % (with respect to the total latex weight) to form a positive control.

Example 4: Clear Semi-Gloss Formulation: A 100-gallon formulation of a clear semi-gloss base paint having a 60-degree gloss rating of about 55 was prepared using the ingredients shown in Table 4. The polymer in Table 4 is a multistage latex composition prepared by a sequential monomer feed process as described above, and including at least a first stage and a second stage and 0.3 wt % (with respect to the total latex weight) STEPCOTE™ W-877 additive, added at the conclusion of polymerization of the latex.

TABLE 4
Clear Semi-Gloss Formulation 4

| Raw Material | Amount (lbs) |
|---|---|
| Water | 231.5 |
| Dispersant | 6.0 |
| Pigment | 30.0 |
| Polymer | 559.2 |
| Defoamer | 3.0 |
| Surfactant | 2.0 |
| Coalescent | 14.8 |
| Neutralizing Agent | 1.0 |
| High-Shear Thickener | 35 |
| High-Shear Thickener | 3.0 |
| Low-Shear Thickener | 9.0 |
| Biocide | 10.0 |
| Biocide | 3.0 |
| Total | 907.5 |

Comparative Example 4-A: For Comparative Example 4-A, in place of the 0.3 wt % STEPCOTE™ W-877 additive, a fluorosurfactant, Thetawet FS-8250 (available from Innovative Chemical Technologies, Inc., Cartersville, GA), was added to the formula of Example 4 in an amount of 0.15 wt % (with respect to the total latex weight) to form a positive control.

### Tinted Coating Examples

Colorant was further added to the clear formulations of Examples 2 and 4 and Comparative Examples 2-A and 4-A. For the clear formulations, the base paint formulation in each case was tinted using black and yellow oxide colorants, where the tinted coatings are indicated below with a “Y” or a “B” for yellow or black tint, respectively. Commercially available, low-VOC colorants (NovoColor® HP II 8600 series colorants available from Color Corporation of America, Rockford, IL) are used for each tint. The colorants were used at a concentration of about 12 ounces of colorant per gallon of the base paint (i.e., 7.5 g/L of colorant) and the colored paint formulations were then coated onto test panels.

Performance results including block resistance, scrub resistance, and early hot block resistance are shown for Examples 1-4 and Comparative Examples 1-A-4-A in Tables 5a-5c, below. All results are averages of ratings for triplicate samples.

TABLE 5a
Performance of White Paints

| | | Hot Block Resistance (Rating) | | |
|---|---|---|---|---|
| | | Days of Cure: | | |
| Ex # | Scrubs | 1 Day | 3 Days | 7 Days |
| 1 | 2000+ | 9 | 9 | 9 |
| 1-A | 2000+ | 8 | 9 | 9 |
| 3 | 2000+ | 8 | 8 | 9 |
| 3-A | 2000+ | 8 | 8 | 9 |

As shown in Table 5a, the performance of Examples 1 and 3 was comparable or superior to that of the comparative examples including fluorosurfactant.

TABLE 5b
Performance of Deeply Colored Semi-Gloss and High-Gloss Paints

| | | Hot Block Resistance (Rating) | | |
|---|---|---|---|---|
| | | Days of Cure: | | |
| Ex # | Scrubs | 1 Day | 3 Days | 7 Days |
| 2-Y | 1943 | 7 | 7 | 7 |
| 2-A-Y | 1965 | 6 | 7 | 8 |
| 2-B | 1823 | 9 | 9 | 9 |
| 2-A-B | 1880 | 7 | 7 | 8 |
| 4-Y | 1925 | 7 | 7 | 7 |
| 4-A-Y | 2000+ | 5 | 7 | 7 |
| 4-B | 2000+ | 7 | 8 | 8 |
| 4-A-B | 2000+ | 7 | 7 | 7 |

As shown in Table 5a, the early hot block resistance of deeply colored Examples 2 and 4 (fluorosurfactant-free) was comparable or superior to that of the comparative examples including fluorosurfactant. For example, Example 2-B exhibited hot block resistance values after 1, 3, and 7 days of cure of “9”, respectively, whereas comparative Example 2-B exhibited the lower values of “7”, “7”, and “8”, respectively.

TABLE 5c
Early Hot Block Resistance of Semi-Gloss Paints

Early Hot Block Resistance (Rating)
Hours of Cure:

| Ex # | 1 Hour | 4 Hours |
|---|---|---|
| 3 | 7 | 8 |
| 3-A | 8 | 8 |
| 4-Y | 7 | 7 |
| 4-A-Y | 1 | 2 |

As shown in Table 5C, the Example 3 white semi-gloss paint (fluorosurfactant-free) exhibited similar early hot block resistance to comparative Example 3-A including fluorosurfactant. Deeply colored (i.e., based on a deep base paint) semi-gloss paint Example 4-Y (fluorosurfactant-free) exhibited markedly improved initial hot block resistance at both 1 and 4 hour cure times relative to fluorosurfactant-containing comparative Example 4-A-Y.

### Clear High-Gloss Paint Examples

The block resistance performance of otherwise equivalent two-stage multistage latexes containing 4 wt % DAAM and 5 wt-% AAEM, respectively, were compared in a clear high-gloss paint formulation, with a block additive of the present disclosure (STEPCOTE™ W-877) and with a conventional blocking fluorosurfactant additive (Thetawet FS-8250). The clear high-gloss paint formulation exhibited a 60-degree gloss rating (after 7 days) of at least 70. The results are shown in Table 6. The two-stage multistage latexes were similar to those of Examples 1-4 above in terms of Tg and other monomer constituents and percentages. The two-stage multistage latexes of this example also included the same anionic emulsifying surfactant similar to those of Example 1-4 described above. Similar to Examples 1-4, the DAAM-containing polymer compositions included a corresponding amount of adipic dihydrazide (ADH) for the amount of DAAM (e.g., slightly less than stoichiometric amount of ADH relative to DAAM).

TABLE 6

| | Comparative | | Comparative | Comparative |
|---|---|---|---|---|
| | Example 5-A | Example 5 | Example 5-B | Example 5-C |
| Crosslinking | 4% DAAM | 4% DAAM | 5% AAEM | 5% AAEM |
| Monomer | | | | |
| Block | FS8250 | W-877 | FS8250 | W-877 |
| Additive: | | | | |
| 1-hour early | 0 | 4 | 0 | 0 |
| block | | | | |
| resistance | | | | |
| 4-hour early | 0 | 7 | 0 | 0 |
| block | | | | |
| resistance | | | | |
| 1-day block | 1 | 6 | 0 | 0 |
| resistance | | | | |
| 7-day block | 4 | 7 | 0 | 1 |
| resistance | | | | |

As shown in Table 6, fluorosurfactant-free Example 5 based on a two-stage latex including 4 wt % DAAM exhibited substantially improved early block resistance (1 hour and 4 hour cure times) and block resistance (after 1 day and 7 day cure times) relative to both comparative Example 5-A including DAAM and fluorosurfactant and Comparative Examples 5-B and 5-C including the crosslinking monomer AAEM in place of DAAM.

### Single Stage Latex Coating Examples

In Example 6 and Comparative Examples 6-A to 6-E shown in Table 7, a single stage latex containing 5 wt % of DAAM and a comparable single stage latex containing 5 wt % of AAEM in place of DAAM were each formulated with no blocking additive, conventional fluorosurfactant blocking additive, and a blocking additive of the present invention to yield otherwise comparable white semi-gloss paints. As is conventional in the art, the single stage latex was prepared with the assistance of an anionic surfactant. The DAAM-containing polymer compositions included a corresponding amount of adipic dihydrazide (ADH) for the amount of DAAM (e.g., slightly less than stoichiometric amount of ADH relative to DAAM). As shown in Table 7, the combination of a DAAM-containing single stage latex and a blocking additive of the present invention (Example 6) performed superior, in a white semi-gloss paint, with respect to block resistance, and especially early block resistance, relative to a comparable AAEM-containing single stage latex in combination with the same blocking additive (Comparative Example 6-C). While the overall block resistance performance of the Example 6 paint was not as good as that of Comparative Ex. 6-E including the same DAAM-containing single stage latex and a fluorosurfactant, the block resistance for Example 6 was still substantial for a paint not containing fluorosurfactant, and especially with respect to early block resistance.

TABLE 7

| | Comp. Ex. | Comp. Ex. | Comp. Ex. | Comp. Ex. | Comp. Ex. | |
|---|---|---|---|---|---|---|
| | 6-A | 6-B | 6-C | 6-D | 6-E | Ex. 6 |
| Crosslinking | 5% AAEM | 5% AAEM | 5% AAEM | 5% DAAM | 5% DAAM | 5% DAAM |
| Monomer | | | | | | |
| Block Additive: | 0 | FS8250 | W-877 | 0 | FS8250 | W-877 |
| 1-hour early | 2.7 | 6 | 0.7 | 0 | 8.3 | 5.7 |
| block resistance | | | | | | |
| 4-hour early | 3.7 | 6 | 3.3 | 0 | 9.3 | 6.3 |
| block resistance | | | | | | |
| 1-day block | 1.7 | 6.7 | 3 | 0.7 | 9.3 | 6.3 |
| resistance | | | | | | |
| 3-day block | 3.7 | 6 | 5.7 | 4.3 | 9.3 | 6.3 |
| resistance | | | | | | |
| 7-day block | 5 | 6.3 | 5.7 | 4.7 | 9 | 6.3 |
| resistance | | | | | | |

In Example 7 and Comparative Examples 7-A to 7-E shown in Table 8, a single stage latex containing 5 wt % of DAAM and a comparable single stage latex containing 5 wt % of AAEM in place of DAAM were each formulated with no blocking additive, conventional fluorosurfactant blocking additive, and a blocking additive of the present invention to yield otherwise comparable clear semi-gloss paints. The DAAM-containing polymer compositions included a corresponding amount of adipic dihydrazide (ADH) for the amount of DAAM (e.g., slightly less than stoichiometric amount of ADH relative to DAAM). As shown in Table 8, the combination of a DAAM-containing single stage latex and a blocking additive of the present invention (Example 7), in a clear semi-gloss paint, exhibited markedly improved overall block resistance relative to a comparable AAEM-containing single stage latex in combination with the same blocking additive (Comparative Example 7-C). Moreover, the Example 7 fluorosurfactant-free, clear semi-gloss paint exhibited an overall block resistance approaching that of Comparative Ex. 7-E, which included a conventional fluorosurfactant blocking additive.

TABLE 8

| | Comp. Ex. | Comp. Ex. | Comp. Ex. | Comp. Ex. | Comp. Ex. | |
|---|---|---|---|---|---|---|
| | 7-A | 7-B | 7-C | 7-D | 7-E | Ex. 7 |
| Crosslinking | 5% AAEM | 5% AAEM | 5% AAEM | 5% DAAM | 5% DAAM | 5% DAAM |
| Monomer | | | | | | |
| Block Additive: | — | FS8250 | W-877 | — | FS8250 | W-877 |
| 1-hour early | 0 | 0 | 0 | 0 | 2 | 0 |
| block resistance | | | | | | |
| 4-hour early | 0 | 0 | 0 | 0 | 1.7 | 0.7 |
| block resistance | | | | | | |
| 1-day block | 0 | 0 | 0 | 4 | 6 | 4 |
| resistance | | | | | | |
| 3-day block | 0 | 0 | 0 | 4 | 6.3 | 5.3 |
| resistance | | | | | | |
| 7-day block | 0 | 0.3 | 2 | 4.7 | 6.3 | 5.7 |
| resistance | | | | | | |

All of the above coating composition examples (i.e., all of worked coating composition Examples 1 through 7-E) were essentially free of VOCs (i.e., contained less than 5 grams of VOCs per liter).

### Prophetic Examples

In the following prophetic examples, colorant compositions are described according to the present invention. Specifically, in the prophetic examples, pigments are dispersed into a vehicle containing water, humectant, optional thickener, optional defoamer, optional amine for pH, surfactant, dispersant, optional preservative, and a non-fluorinated, non-polymeric phosphate ester additive having a non-substituted, linear alkyl chain. The percentages indicated are weight percentages.

TABLE 6
Black colorant formulation
Black Colorant

| | |
|---|---|
| Water | 46.40% |
| Humectant | 4.20% |
| Thickener | 1.20% |
| Defoamer | 0.40% |
| Amine for pH | 0.10% |
| Surfactant | 2.80% |
| Dispersant | 1.40% |
| Preservative | 0.50% |
| Non-fluorinated, non- | 3.00% |
| polymeric additive | |
| Extender Pigment | 30.80% |
| Carbon Black Pigment | 9.20% |
| | 100.00% |

TABLE 7
Yellow colorant formulation
Yellow Oxide Colorant

| | |
|---|---|
| Water | 24.40% |
| Humectant | 6.00% |
| Thickener | 1.00% |
| Defoamer | 0.30% |
| Amine for pH | 0.50% |
| Surfactant | 6.60% |
| Dispersant | 1.90% |
| Preservative | 0.50% |
| Non-fluorinated, non- | 3.00% |
| polymeric additive | |
| Yellow Iron Oxide Pigment | 55.80% |
| | 100.00% |

In these prophetic examples, the colorant compositions are added to base paints having the formulations of Examples 2 and 4, wherein the 0.3 wt % non-fluorosurfactant, non-polymeric additive is not added to the base paint prior to tinting with colorant, to test compatibility and performance. The colorant compositions are added volumetrically, depending on the base used. Compared to commercially available colorants, the colorants of the present invention are expected to provide superior colorant performance in terms of block and tack resistance, scrub and stain resistance, and resistance to dirt pickup.

### Prophetic Example: Colorant Array

A commercially available, 14-colorant array is modified by adding 3 wt % of non-fluorinated, non-polymeric phosphate ester additive having a non-substituted alkyl chain to each colorant in the array. The colorants contain conventional dispersants, extenders, surfactants, defoamers and preservatives, together with pigments in the amounts shown in Table 8, below. The modified colorants are ground using zirconium milling beads to a 7 Hegman fineness of grind value.

TABLE 8
Colorant pigment formulation information

| Colorant Hue | Pigment | Wt. % Pigment |
|---|---|---|
| White | PW6 | 55.43 |
| Black | PBK7 | 8.95 |
| Organic Yellow | PY74 | 32.26 |
| Medium Yellow | PY74 + PY83 | 37.14 |
| Durable Yellow | PY74 + PY184 | 52.14 |
| Green | PG7 | 19.97 |
| Blue | PB15:2 | 14.38 |
| Interior Red | PR112 | 10.97 |
| Exterior Red | PR254 | 14.8 |
| Magenta | PR122 | 15.17 |
| Orange | PO73 | 25.31 |
| Yellow Oxide | PY42 | 55.36 |
| Red Oxide | PR101 | 62.39 |
| Raw Umber | PBR7 | 19.91 |

In this prophetic example, paints containing modified colorants are compared to paints containing un-modified colorants for physical performance tinted at equal volume % colorant level, using the base paints having the formulations of Examples 2 and 4, wherein the 0.3 wt % non-fluorosurfactant, non-polymeric additive is not added to the base paint prior to tinting with colorant. The colorant array utilizing the present invention are expected to provide superior performance in terms of block and tack resistance, scrub and stain resistance, and resistance to dirt pickup compared to the un-modified colorant array.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1. An in-store tintable aqueous paint composition having less than 50 grams of VOC per liter, wherein the in-store tintable aqueous paint composition includes:
a latex copolymer formed from monomers including diacetone acrylamide (DAAM);
one or more emulsifying surfactants;
a non-fluorinated, non-polymeric additive that includes (i) an acid group that has been neutralized with a base, wherein the acid group includes at least one sulfur or phosphorus atom and (ii) a linear or branched, substituted or unsubstituted alkyl group;
wherein the composition includes less than 0.01 wt % of fluorosurfactants, if any, based on the total weight of the composition;
wherein the composition has one or both of (i) a pigment to volume concentration (PVC) of 20% or less or (ii) a 60-degree gloss rating of 70 or higher;
wherein the non-fluorinated, non-polymeric additive, prior to neutralization with base, comprises an alkyl phosphate ester, wherein the alkyl phosphate ester has the structure: 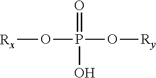
wherein:
Rx represents a linear or branched substituted or unsubstituted alkyl group,
Ry represents a linear or branched substituted or unsubstituted alkyl group,
x represents the number of carbon atoms in the branched or linear alkyl group of Rx and ranges from 5 to 10,
y represents the number of carbon atoms in the branched or linear alkyl group of Ry and is 0 (in which case Ry is a hydrogen atom) or ranges from 5 to 10; and
wherein the non-fluorinated, non-polymeric additive is a reaction product of ingredients including 1-octanol.

2. The composition of claim 1, wherein the in-store tintable aqueous paint composition is an in-store tintable aqueous base paint.

3. The composition of claim 2, wherein the in-store tintable aqueous paint composition is an in-store tintable aqueous deep base for use in forming deeply colored finish paint via addition of one or more colorant compositions.

4. The composition of claim 1, wherein the latex copolymer is formed of at least 80 wt % of two or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex copolymer.

5. The composition of claim 2, wherein the latex copolymer is formed of at least 90 wt % of three or more monomers selected from methyl methacrylate, ethyl acrylate, vinyl acetate, tert-butyl methacrylate, n-butyl methacrylate, styrene, tert-butyl acrylate, n-butyl acrylate, 2-ethyl hexyl acrylate, methyl acrylate, and esters of itaconic acid, based on the total weight of monomers used to form the latex copolymer.

6. The composition of claim 1, wherein the latex copolymer includes at least about 0.5 wt % of DAAM, based on the total weight of monomers used to make the latex copolymer.

7. The composition of claim 2, wherein the latex copolymer includes at least about 2.5 wt % of DAAM, based on the total weight of monomers used to make the latex copolymer.

8. The composition of claim 1, wherein the latex copolymer is a multi-stage latex copolymer that includes at least two stages with different Tg values, and wherein the difference in Tg values is at least about 35° C.

9. The composition of claim 8, wherein the difference in Tg values is from about 35° C. to about 100° C.

10. The composition of claim 8, wherein at least one stage of the multi-stage latex copolymer has a calculated Tg of −35° C. to 20° C.

11. The composition of claim 10, wherein at least another stage of the multi-stage latex copolymer has a calculated Tg of from 0 to 120° C.

12. The composition of claim 8, wherein each of the recited stages is present in an amount of at least 20 wt %, based on the weight of monomers used to make each stage relative to the total amount of monomers used to make the latex copolymer.

13. The composition of claim 1, wherein the composition has one or both of: (i) a pigment to volume concentration (PVC) of 30% or less or (ii) a 60-degree gloss rating of 35 or higher.

14. (canceled)

15. The composition of claim 1, wherein the composition is a semi-gloss architectural paint formulation.

16. The composition of claim 1, wherein the composition is a high gloss architectural paint formulation.

17. (canceled)

18. The composition of claim 1, wherein Rx and Ry include only carbon and hydrogen atoms, and wherein at least one, or both, of Rx and Ry include eight carbon atoms.

19. (canceled)

20. The composition of claim 1, wherein the non-fluorinated, non-polymeric additive is present in the composition in an amount of at least 0.2 pounds per 100 gallons of the composition.

21. The composition of claim 20, wherein the non-fluorinated, non-polymeric additive is present in the composition in an amount of no more than about 4 pounds per 100 gallons of the composition.

22. The composition of claim 1, wherein the composition is (i) an in-store tintable aqueous base paint for use in forming deeply colored architectural finish paint via addition of one or more colorant compositions or (ii) a deeply colored architectural finish paint, and wherein the composition has an early hot block resistance rating after one hour of at least 6.

23. The composition of claim 22, wherein the composition when applied to a black mylar substrate and allowed to cure for 1 week at ambient temperature to achieve an average dry coating thickness of 2.6 mil has a scrub resistance of at least 600 scrubs.

24. The composition of claim 1, wherein the composition contains less than 1000 parts per billion (ppb) of elemental fluorine as it occurs in all chemical species in the composition, if any is present.

25. The composition of claim 1, wherein the composition is a deeply colored architectural finish paint that includes at least about 10 ounces of colorant per 1 gallon.

26. The composition of claim 8, wherein the composition includes at least 20 wt % of the multi-stage latex copolymer, based on solids of the multi-stage latex copolymer relative to total solids in the composition.

27. The composition of claim 1, wherein the composition includes a polyhydrazide; and/or wherein the composition includes methyl-o-benzoyl-benzoate.

28. The composition of claim 1, wherein the emulsifying surfactant is one or more non-ionic surfactants, anionic surfactants, or combinations thereof, and/or wherein the latex copolymer is polymerized using the one or more emulsifying surfactants.

29. The composition of claim 1, wherein the one or more emulsifying surfactants is chemically distinct from the non-fluorinated, non-polymeric additive.

30. The composition of claim 1, wherein the non-fluorinated, non-polymeric additive does not facilitate polymerization of monomers in an aqueous media.

31. The composition of claim 1, wherein the composition has an early hot block resistance rating at 50° C. and after one hour of at least 6.

32. The composition of claim 1, wherein the composition has an early hot block resistance rating at 50° C. and after one hour of at least 6.

33. The composition of claim 21, wherein the composition has an early hot block resistance rating at 50° C. and after one hour of at least 6.
